(19) United States
(12) Patent Application Publication
(10) Pub. No.: US 2025/0251166 A1
(43) Pub. Date: Aug. 7, 2025

(54) AIR CONDITIONER INCLUDING RADAR SENSOR AND METHOD OF CONTROLLING OPERATION OF AIR CONDITIONER

(71) Applicant: SAMSUNG ELECTRONICS CO., LTD., Suwon-si (KR)

(72) Inventors: Hyeonghwan CHOI, Suwon-si (KR); Yuncheol SHIN, Suwon-si (KR)

(21) Appl. No.: 18/887,824

(22) Filed: Sep. 17, 2024

Related U.S. Application Data
(63) Continuation of application No. PCT/KR2024/012935, filed on Aug. 29, 2024.

(30) Foreign Application Priority Data
Feb. 5, 2024 (KR) 10-2024-0017692
Apr. 15, 2024 (KR) 10-2024-0050301

(51) Int. Cl. F24F 11/65; F24F 11/61; F24F 11/79; F24F 11/89; F24F 120/12; F24F 120/14

(52) U.S. Cl. CPC F24F 11/65; F24F 11/61; F24F 11/79; F24F 11/89; F24F 2120/12; F24F 2120/14

(57) ABSTRACT

Provided is an air conditioner including an indoor unit main body including a heat exchanger, a blower, and a blade, a radar sensor provided inside the indoor unit main body and configured to detect a person, and a sensor mounting portion on which the radar sensor is mounted to be tilted at a preset angle and directed toward a floor surface, wherein, when the indoor unit main body is located on one side of a ceiling, the preset angle is an angle between 50° and 70°.

### CROSS-REFERENCE TO RELATED APPLICATIONS

This application is a continuation application, claiming priority under § 365 (c), of International Application No. PCT/KR2024/012935 filed on Aug. 29, 2024, which is based on and claims the benefit of Korean patent application number 10-2024-0050301 filed on Apr. 15, 2024, in the Korean Intellectual Property Office and of Korean patent application number 10-2024-0017692 filed on Feb. 5, 2024, in the Korean Intellectual Property Office, the disclosures of which are incorporated by reference herein in their entireties.

### TECHNICAL FIELD

Embodiments of the disclosure relate to an air conditioner including a radar sensor and a method of controlling an operation of the air conditioner.

### BACKGROUND ART

Air conditioners are apparatuses or home appliances that control indoor air conditions and may cool (or heat) or dehumidify the air. Recently, passive infrared (PIR) sensors may also be used in air conditioners for human detection. A PIR sensor detects heat sources (or infrared rays) and determines the presence of a person by detecting heat sources (or infrared rays) of the person. However, the PIR sensor is unable to detect the exact location of the person. The PIR sensor may only notify a microcontroller unit (MCU) in an air conditioner of the presence of a person within a predefined area. Also, the PIR sensor is unable to identify distance and is thus unable to determine whether a person is close to or far from the air conditioner. Accordingly, air conditioners including the PIR sensor have limitations in providing convenient services based on the location of a person.

### DISCLOSURE

### Technical Solution

According to an embodiment of the disclosure, an air conditioner may include an indoor unit main body including a heat exchanger, a blower, and a blade, a radar sensor provided inside the indoor unit main body and configured to detect a person, and a sensor mounting portion on which the radar sensor is mounted to be tilted at a preset angle and directed toward a floor surface. When the indoor unit main body is located on one side of a ceiling, the preset angle may be an angle between 50° and 70°.

According to an embodiment of the disclosure, an air conditioner may include an indoor unit main body including a heat exchanger, a blower, and a blade, a radar sensor provided inside the indoor unit main body and directed toward a floor surface, a memory storing one or more instructions, and at least one processor. The at least one processor may be configured to execute the one or more instructions to obtain, by using the radar sensor, information about a location of at least one person detected within a certain range from the air conditioner. The at least one processor may identify, by using the information about the location of the at least one person, an activity level of the at least one person. The at least one processor may determine, based on the activity level of the at least one person, a wind volume of the air conditioner. The at least one processor may control the blower to discharge wind with the determined wind volume.

According to an embodiment of the disclosure, a method of controlling an operation of an air conditioner may include, by using a radar sensor provided inside an indoor unit main body and directed toward a floor surface, obtaining information about a location of at least one person detected within a certain range from the air conditioner, by using the information about the location of the at least one person, identifying an activity level of the at least one person, based on the activity level of the at least one person, determining a wind volume of the air conditioner, and controlling a blower of the air conditioner to discharge wind with the determined wind volume.

### DESCRIPTION OF DRAWINGS

FIG. 1 is a diagram to describe an air conditioner according to an embodiment of the disclosure.

FIG. 2 is a diagram to describe a radar sensor according to an embodiment of the disclosure.

FIG. 3 is a diagram to describe an installation angle of a radar sensor according to an embodiment of the disclosure.

FIG. 4 is a diagram to describe a sensor mounting portion according to an embodiment of the disclosure.

FIG. 5 is a diagram to describe an operation of detecting a plurality of people by using a radar sensor, according to an embodiment of the disclosure.

FIG. 6 is a diagram to describe coordinates of a plurality of people detected by using a radar sensor, according to an embodiment of the disclosure.

FIG. 7 is a block diagram to describe functions of an air conditioner according to an embodiment of the disclosure.

FIG. 8 is a diagram to describe a communication system of an air conditioner according to an embodiment of the disclosure.

FIG. 9 is a flowchart to describe a method for an air conditioner to control wind volume, according to an embodiment of the disclosure.

FIG. 10 is a diagram to describe an operation of an air conditioner to control wind volume, according to an embodiment of the disclosure.

FIG. 11 is a flowchart to describe a method for an air conditioner to control wind volume according to the number of people, according to an embodiment of the disclosure.

FIG. 12 is a diagram to describe an operation of an air conditioner to control wind volume according to the number of people and an activity level of each person, according to an embodiment of the disclosure.

FIG. 13 is a diagram to describe a method for an air conditioner to adjust an angle of a blade based on a location of a person, according to an embodiment of the disclosure.

FIG. 14 is a diagram of a graphical user interface (GUI) for setting a direct wind mode or an indirect wind mode, according to an embodiment of the disclosure.

FIG. 15 is a diagram to describe an operation of an air conditioner to adjust an angle of a blade based on a location of a person, according to an embodiment of the disclosure.

FIG. 16 is a flowchart to describe a method for an air conditioner to operate in an energy saving mode when the absence of a person is detected, according to an embodiment of the disclosure.

FIG. 17 is a flowchart to describe a method for an air conditioner to adjust an energy saving operation time according to an absence pattern of a person, according to an embodiment of the disclosure.

FIG. 18 is a diagram to describe an operation of an air conditioner to adjust an energy saving operation time according to an absence pattern of a person, according to an embodiment of the disclosure.

FIG. 19 is a diagram of a GUI for setting an energy saving mode, according to an embodiment of the disclosure.

FIG. 20 is a flowchart to describe a method for Internet-of-things (IoT) devices connected to an air conditioner to switch to an energy saving mode, according to an embodiment of the disclosure.

FIG. 21 is a diagram to describe an operation of IoT devices connected to an air conditioner to switch to an energy saving mode, according to an embodiment of the disclosure.

FIG. 22 is a flowchart to describe a method for an air conditioner to output a security detection notification, according to an embodiment of the disclosure.

FIG. 23 is a diagram to describe an operation of a user terminal to output a security detection notification, according to an embodiment of the disclosure.

FIG. 24 is a flowchart to describe a method for an air conditioner to output a notification attracting a person's attention to an increase in the activity level, according to an embodiment of the disclosure.

FIG. 25 is a diagram to describe an operation of an air conditioner or a user terminal to output a notification attracting/drawing a person's attention to an increase in the activity level, according to an embodiment of the disclosure.

### DETAILED DESCRIPTION

The terms used in the disclosure will be briefly defined, and embodiments of the disclosure will be described in detail.

All terms used in the disclosure are those general terms currently widely used in the art in consideration of functions in regard to embodiments of the disclosure, but the terms may vary according to the intention of those of ordinary skill in the art, precedents, or new technologies in the art. Furthermore, some particular terms may be arbitrarily selected by the applicant, and in this case, the meaning of the selected terms will be described in detail in the detailed description of the disclosure. Thus, the terms used in the disclosure should be understood not as simple names but based on the meaning of the terms and the overall description of the disclosure.

Throughout the disclosure, the expression “at least one of a, b or c” indicates “a”, “b”, “c”, “a and b”, “a and c”, “b and c”, “a, b, and c”, or variations thereof.

Throughout the disclosure, when a portion “includes” or “comprises” a component, another component may be further included, rather than excluding the presence of the other component, unless otherwise described. In addition, terms “ . . . or/er”, “ . . . module”, etc. used in the disclosure refer to units that perform at least one function or operation, and the “ . . . or/er” and “ . . . module” may be implemented as hardware or software or as a combination of hardware and software.

It should be understood that blocks in each flowchart and combinations of flowcharts may be performed by one or more computer programs including computer-executable instructions. The one or more computer programs may all be stored in a single memory or may be divided and stored in different memories.

It is to be understood that the singular forms, e.g., “a”, “an”, and “the”, include the plural forms as well, unless the context clearly indicates otherwise. Thus, for example, the term “a component surface” may also include one or more of such surfaces.

Any function or operation described in the present document may be performed by a single processor or a combination of processors. The single processor or the combination of processors may include circuitry that performs processing, such as an application processor (AP), a communication processor (CP), a graphical processing unit (GPU), a neural processing unit (NPU), a microprocessor unit (MPU), a system on chip (SoC), or an integrated chip (IC).

Hereinafter, embodiments of the disclosure will be described in detail with reference to the accompanying drawings such that one of ordinary skill in the art may easily implement the embodiments of the disclosure. The disclosure may, however, be embodied in many different forms and should not be construed as limited to the embodiments of the disclosure set forth herein. In addition, components not related to description are omitted in the drawings for clear description of an embodiment of the disclosure, and like reference numerals in the drawings denote like components throughout the disclosure.

An air conditioner according to an embodiment of the disclosure is an apparatus that performs functions, such as air purification, ventilation, humidity control, cooling, or heating in an air conditioning space (hereinafter referred to as an “indoor space”), and refers to an apparatus having at least one of these functions.

According to an embodiment of the disclosure, the air conditioner may include a heat pump apparatus to perform a cooling function or a heating function. The heat pump apparatus may include a refrigeration cycle in which a refrigerant is circulated along a compressor, a first heat exchanger, an expansion apparatus, and a second heat exchanger. All components of the heat pump apparatus may be built into a single housing that forms the exterior of an air conditioner, and window-type air conditioners or portable air conditioners are examples of such air conditioners. In contrast, some components of the heat pump apparatus may be divided and built into a plurality of housings that form a single air conditioner, and such air conditioners include wall-mounted air conditioners, stand-alone air conditioners, and system air conditioners.

An air conditioner including a plurality of housings may include at least one outdoor unit installed outdoors and at least one indoor unit installed indoors. For example, the air conditioner may be provided such that one outdoor unit is connected to one indoor unit through refrigerant pipes. For example, the air conditioner may be provided such that one outdoor unit is connected to two or more indoor units through refrigerant pipes. For example, the air conditioner may be provided such that two or more outdoor units are connected to two or more indoor units through a plurality of refrigerant pipes.

The outdoor unit may be electrically connected to the indoor unit. For example, information (or commands) for controlling the air conditioner may be input through an input interface provided on the outdoor unit or the indoor unit, and the outdoor unit and the indoor unit may simultaneously or sequentially operate in response to an input from a user.

The air conditioner may include an outdoor heat exchanger provided in the outdoor unit, an indoor heat exchanger provided in the indoor unit, and a refrigerant pipe that connects the outdoor heat exchanger and the indoor heat exchanger to each other.

The outdoor heat exchanger may exchange heat between a refrigerant and outdoor air by using a phase change (e.g., evaporation or condensation) of the refrigerant. For example, while the refrigerant condenses in the outdoor heat exchanger, the refrigerant may release heat to the outdoor air, and while the refrigerant flowing through the outdoor heat exchanger evaporates, the refrigerant may absorb heat from the outdoor air.

The indoor unit is provided indoors. For example, the indoor unit may be classified (formed, assembled, and/or categorized) into a ceiling-mounted indoor unit, a stand-alone indoor unit, or a wall-mounted indoor unit according to an installation method. For example, a ceiling-mounted indoor unit may be classified into a 4-way indoor unit, a 1-way indoor unit, or a duct-type indoor unit according to an air discharge scheme.

Similarly, the indoor heat exchanger may exchange heat between a refrigerant and indoor air by using a phase change (e.g., evaporation or condensation) of the refrigerant. For example, while the refrigerant evaporates in the indoor unit, the refrigerant may absorb heat from the indoor air, and an indoor space may be cooled by blowing the indoor air cooled by passing through the cooled indoor heat exchanger. Also, while the refrigerant condenses in the indoor heat exchanger, the refrigerant may release heat to the indoor air, and the indoor space may be heated by blowing the indoor air heated by passing through the high-temperature indoor heat exchanger.

That is, the air conditioner performs a cooling function or a heating function through a phase change process of the refrigerant circulating through the outdoor heat exchanger and the indoor heat exchanger. For such circulation of the refrigerant, the air conditioner may include a compressor that compresses the refrigerant. The compressor may absorb refrigerant gas through a suction portion and compress the refrigerant gas. The compressor may discharge high-temperature and high-pressure refrigerant gas through a discharge portion. The compressor may be arranged inside the outdoor unit.

Through the refrigerant pipe, the refrigerant may circulate in the order of the compressor, the outdoor heat exchanger, an expansion apparatus, and the indoor heat exchanger, or may circulate in the order of the compressor, the indoor heat exchanger, the expansion apparatus, and the outdoor heat exchanger.

For example, when the air conditioner includes one outdoor unit and one indoor unit directly connected to each other through a refrigerant pipe, the refrigerant may circulate between the one outdoor unit and the one indoor unit through the refrigerant pipe.

For example, when the air conditioner includes one outdoor unit connected to two or more indoor units through refrigerant pipes, the refrigerant may flow to the plurality of indoor units through the refrigerant pipes branching from the outdoor unit. Refrigerants discharged from the plurality of indoor units may be combined and circulate to the outdoor unit. For example, the plurality of indoor units may be directly connected to one outdoor unit in parallel through separate refrigerant pipes.

Each of the plurality of indoor units may operate independently according to an operation mode set by a user. That is, some of the plurality of indoor units may operate in a cooling mode, and others of the indoor units may simultaneously operate in a heating mode. In this case, the refrigerant may selectively flow into each indoor unit at high pressure or low pressure along a designated circulation path through a flow path switching valve to be described below, and discharged to circulate to the outdoor unit.

For example, when the air conditioner includes two or more outdoor units connected to two or more indoor units through a plurality of refrigerant pipes, refrigerants discharged from the plurality of outdoor units may be combined and flow through one refrigerant pipe, and then branch off again at a certain point and flow into the plurality of indoor units.

According to an operation load caused by the operation volume of the plurality of indoor units, the plurality of outdoor units may all be driven or at least some of the outdoor units may not be driven. In this case, the refrigerant may flow into and circulate in selectively driven outdoor units through the flow path switching valve. The air conditioner may include an expansion apparatus to lower the pressure of the refrigerant flowing into the heat exchanger. For example, the expansion apparatus may be arranged inside the indoor unit or inside the outdoor unit, or may be arranged in both the indoor and outdoor units.

For example, the expansion apparatus may lower the temperature and pressure of the refrigerant by using a throttle effect. The expansion apparatus may include an orifice that may reduce a cross-sectional area of a flow path. The temperature and pressure of the refrigerant passing or passed through the orifice may be lowered.

For example, the expansion apparatus may be implemented as an electronic expansion valve that may adjust an opening ratio (e.g., ratio of a cross-sectional area of a flow path of a valve in a partially open state to a cross-sectional area of the flow path of the valve in a fully open state). The amount of refrigerant passing through the expansion apparatus may be controlled according to the opening ratio of the electronic expansion valve.

The air conditioner may further include a flow path switching valve arranged in a refrigerant circulation flow path. The flow path switching valve may include, for example, a 4-way valve. The flow path switching valve may determine a circulation path of the refrigerant based on an operation mode (e.g., a cooling operation or a heating operation) of the indoor unit. The flow path switching valve may be connected to the discharge portion of the compressor.

The air conditioner may include an accumulator. The accumulator may be connected to the suction portion of the compressor. The accumulator may receive a low-temperature and low-pressure refrigerant that has evaporated from the indoor heat exchanger or the outdoor heat exchanger.

When a refrigerant, which is a mixture of refrigerant liquid and refrigerant gas, is introduced, the accumulator may separate the refrigerant liquid from the refrigerant gas and provide, to the compressor, the refrigerant gas from which the refrigerant liquid has been separated.

An outdoor fan may be provided in the vicinity of the outdoor heat exchanger. The outdoor fan may blow outdoor air to the outdoor heat exchanger to facilitate heat exchange between the refrigerant and the outdoor air.

The outdoor unit of the air conditioner may include at least one sensor. For example, an outdoor unit sensor may be provided as an environmental sensor. The outdoor unit sensor may be arranged at any location inside or outside the outdoor unit. For example, the outdoor unit sensor may include a temperature sensor that detects the temperature of air around the outdoor unit, a humidity sensor that detects the humidity of air around the outdoor unit, a refrigerant temperature sensor that detects the temperature of a refrigerant in a refrigerant pipe passing through the outdoor unit, and/or a refrigerant pressure sensor that detects the pressure of a refrigerant in a refrigerant pipe passing through the outdoor unit.

The outdoor unit of the air conditioner may include an outdoor unit communicator. The outdoor unit communicator may be provided to receive a control signal from an indoor unit controller of the air conditioner, wherein the indoor unit controller is to be described below. The outdoor unit may control an operation of the compressor, the outdoor heat exchanger, the expansion apparatus, the flow path switching valve, the accumulator, and/or the outdoor fan, based on the control signal received through the outdoor unit communicator. The outdoor unit may transmit a sensing value to the indoor unit controller through the outdoor unit communicator, the sensing value being detected from the outdoor unit sensor.

The indoor unit of the air conditioner may include a housing, a blower that circulates air into or out of the housing, and an indoor heat exchanger that exchanges heat with air flowing into the housing.

The housing may include an intake port. The indoor air may flow into the housing through the intake port.

The indoor unit of the air conditioner may include a filter provided to filter foreign materials in the air flowing into the housing through the intake port.

The housing may include a discharge port. The air flowing inside the housing may be discharged to the outside of the housing through the discharge port.

An airflow guide that guides a direction of air discharged through the discharge port may be provided in the housing of the indoor unit. For example, the airflow guide may include a blade positioned on the discharge port. For example, the airflow guide may include an auxiliary fan that controls an exhaust airflow. The disclosure is not limited thereto, and the airflow guide may be omitted.

The indoor heat exchanger and the blower, which are arranged in a flow path that connects the intake port and the discharge port to each other, may be provided inside the housing of the indoor unit.

The blower may include an indoor fan and a fan motor. For example, the indoor fan may include an axial fan, a radial fan, a crossflow fan, or a centrifugal fan.

The indoor heat exchanger may be between the blower and the discharge port or may be between the intake port and the blower. The indoor heat exchanger may absorb heat from the air introduced through the intake port or transfer heat to the air introduced through the intake port. The indoor heat exchanger may include a heat exchange pipe through which a refrigerant flows, and a heat exchange fin in contact with the heat exchange pipe to increase a heat transfer area.

The indoor unit of the air conditioner may include a drain tray arranged below the indoor heat exchanger to collect condensate (or condensation) generated in the indoor heat exchanger. The condensate accommodated in the drain tray may be drained to the outside through a drain hose. The drain tray may be provided to support the indoor heat exchanger.

The indoor unit of the air conditioner may include an input interface. The input interface may include any type of user input means including a button, a switch, a touch screen, and/or a touch pad. A user may directly input setting data (e.g., a desired indoor temperature, operation mode settings for cooling/heating/dehumidification/air purification, outlet selection settings, and/or wind volume settings) through the input interface. Wind refers to airflow, particularly the motion of air. The volume, speed, and/or amount of airflow can be increased or decreased to have a greater of lesser flow of air.

The input interface may also be connected to an external input apparatus. For example, the input interface may be electrically connected to a wired remote controller. The wired remote controller may be installed at a specific location in an indoor space, such as on an area of a wall. The user may input setting data regarding an operation of the air conditioner by operating the wired remote controller. An electrical signal corresponding to the setting data obtained through the wired remote controller may be transmitted to the input interface. Also, the input interface may include an infrared sensor. The user may remotely input setting data regarding the operation of the air conditioner by using a wireless remote controller. The setting data input through the wireless remote controller may be transmitted to the input interface as an infrared signal.

Also, the input interface may include a microphone. A speech command from the user may be obtained through the microphone. The microphone may convert the speech command from the user into an electrical signal and transmit the converted electrical signal to the indoor unit controller. The indoor unit controller may control components of the air conditioner to execute functions corresponding to speech commands from the user. The setting data (e.g., a desired indoor temperature, operation mode settings for cooling/heating/dehumidification/air purification, outlet selection settings, and/or wind volume settings) obtained through the input interface may be transmitted to the indoor unit controller to be described below. For example, the setting data obtained through the input interface may be transmitted to an external source, that is, an outdoor unit or a server, through an indoor unit communicator to be described below.

The indoor unit of the air conditioner may include a power module. The power module may be connected to an external power source and supply power to components of the indoor unit.

The indoor unit of the air conditioner may include an indoor unit sensor. The indoor unit sensor may include an environmental sensor arranged in a space inside or outside the housing. For example, the indoor unit sensor may include one or more temperature sensors and/or humidity sensors arranged in a preset space inside or outside the housing of the indoor unit. For example, the indoor unit sensor may include a refrigerant temperature sensor that detects the temperature of a refrigerant in a refrigerant pipe passing through the indoor unit. For example, the indoor unit sensor may include refrigerant temperature sensors that respectively detect the temperatures of an inlet, a middle portion, and/or an outlet of a refrigerant pipe passing through the indoor heat exchanger.

For example, each piece of environmental information detected by the indoor unit sensor may be transmitted to the indoor unit controller to be described below or may be transmitted to the outside through the indoor unit communicator to be described below.

The indoor unit of the air conditioner may include an indoor unit communicator. The indoor unit communicator may include at least one of a short-range communication module or a long-range communication module. The indoor unit communicator may include at least one antenna that wirelessly communicates with another apparatus. The outdoor unit may include an outdoor unit communicator. The outdoor unit communicator may include at least one of a short-range communication module or a long-range communication module.

The short-range communication module may include, but is not limited to, a Bluetooth communication module, a Bluetooth low energy (BLE) communication module, a near-field communication (NFC) module, a wireless local area network (WLAN) (e.g., Wi-Fi) communication module, a ZigBee communication module, an infrared data association (IrDA) communication module, a Wi-Fi direct (WFD) communication module, an ultra-wideband (UWB) communication module, an Ant+ communication module, or a microwave (uWave) communication module.

The long-range communication module may include a communication module that performs various types of long-range communication and may include a mobile communicator. The mobile communicator transmits and receives wireless signals to and from at least one of a base station, an external terminal, or a server in a mobile communication network.

The indoor unit communicator may communicate with an external apparatus such as a server, a mobile apparatus, and/or another home appliance via a nearby access point (AP). The AP may connect a local area network (LAN) to which the air conditioner or a user device is connected to a wide area network (WAN) to which a server is connected. The air conditioner or the user device may be connected to a server via a WAN. The indoor unit of the air conditioner may include an indoor unit controller that controls the components of the indoor unit, including a blower. The outdoor unit of the air conditioner may include an outdoor unit controller that controls components of the outdoor unit, including a compressor. The indoor unit controller may communicate with the outdoor unit controller through the indoor unit communicator and the outdoor unit communicator. The outdoor unit communicator may transmit, to the indoor unit communicator, a control signal generated by the outdoor unit controller or may transmit, to the outdoor unit controller, a control signal transmitted from the indoor unit communicator. That is, the outdoor unit and the indoor unit may perform bidirectional communication with each other. The outdoor unit or the indoor unit may transmit and receive various signals generated during the operation of the air conditioner.

The outdoor unit controller may be electrically connected to the components of the outdoor unit and may control the operation of each component. For example, the outdoor unit controller may adjust a frequency of the compressor and control the flow path switching valve to change a circulation direction of the refrigerant. The outdoor unit controller may adjust the rotation speed of an outer fan. Also, the outdoor unit controller may generate a control signal to adjust the opening of an expansion valve. Under control by the outdoor unit controller, the refrigerant may circulate along a refrigerant circulation flow path including the compressor, the flow path switching valve, the outdoor heat exchanger, the expansion valve, and the indoor heat exchanger.

Various temperature sensors included in the outdoor unit and the indoor unit may transmit, to the outdoor unit controller and/or the indoor unit controller, electrical signals corresponding to respective detected temperatures. For example, humidity sensors included in the outdoor unit and the indoor unit may transmit, to the outdoor unit controller and/or the indoor unit controller, electrical signals corresponding to respective detected humidities.

The indoor unit controller may obtain a user input from a user apparatus, including a mobile device, through the indoor unit communicator and may obtain a user input directly through the input interface or through a remote controller. The indoor unit controller may control the components of the indoor unit, including a blower, in response to a received user input. The indoor unit controller may transmit, to the outdoor unit controller of the outdoor unit, information about the received user input.

The outdoor unit controller may control the components of the outdoor unit, including a compressor, based on the information about the user input received from the indoor unit. For example, when a control signal corresponding to a user input for selecting an operation mode, such as cooling operation, heating operation, ventilation operation, defrosting operation, or dehumidification operation, is received from the indoor unit, the outdoor unit controller may control the components of the outdoor unit to perform an operation of the air conditioner corresponding to the selected operation mode.

The outdoor unit controller and the indoor unit controller may each include a processor and a memory. The indoor unit controller may include at least one first processor and at least one first memory, and the outdoor unit controller may include at least one second processor and at least one second memory.

The memory may store various types of information necessary for the operation of the air conditioner. The memory may store instructions, applications, data, and/or programs necessary for the operation of the air conditioner. For example, the memory may store various programs for cooling operation, heating operation, dehumidification operation, and/or defrosting operation of the air conditioner. The memory may include volatile memory, such as static random access memory (S-RAM) or dynamic RAM (D-RAM), for temporary storage of data. Also, the memory may include nonvolatile memory, such as read-only memory (ROM), erasable programmable ROM (EPROM), or electrically erasable programmable ROM (EEPROM), for long-term storage of data.

The processor may generate control signals for controlling the operation of the air conditioner based on the instructions, applications, data, and/or programs stored in the memory. The processor is hardware and may include a logic circuit and an arithmetic circuit. The processor may process data according to a program and/or instruction provided from the memory and generate a control signal according to a result of the processing. The memory and the processor may be implemented as a single control circuit or may be implemented a plurality of circuits.

The indoor unit of the air conditioner may include an output interface. The output interface may be electrically connected to the indoor unit controller and may output information related to the operation of the air conditioner under control by the indoor unit controller. For example, information, such as an operation mode, wind direction, wind volume, and/or temperature selected by a user input, may be output. Also, the output interface may output sensing information and warning/error messages obtained from the indoor unit sensor or the outdoor unit sensor.

The output interface may include a display and a speaker. The speaker is an audio apparatus and may output various sounds. The display may display, as various graphic elements, information input by the user or information provided to the user. For example, operation information about the air conditioner may be displayed as at least one of an image or text. Also, the display may include an indicator that provides certain information. The display may include a liquid crystal display (LCD) panel, a light-emitting diode (LED) panel, an organic LED (OLED) panel, a micro LED panel, and/or a plurality of LEDs.

Hereinafter, the air conditioner according to various embodiments is described in detail with reference to the drawings.

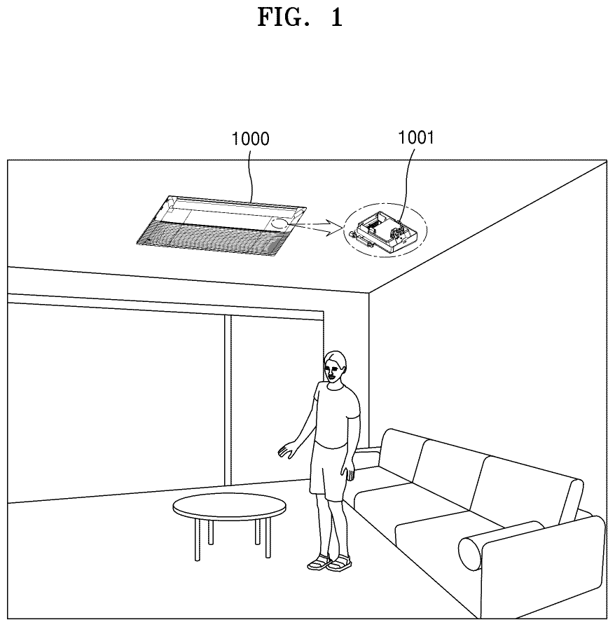

FIG. 1 is a diagram to describe an air conditioner 1000 according to an embodiment of the disclosure.

The air conditioner 1000 may be an apparatus that performs functions, such as air purification, ventilation, humidity control, cooling, and/or heating in an indoor space. The air conditioner 1000 may include, but is not limited to, an air conditioner (hereinafter also referred to as a 1-way ceiling-mounted air conditioner) that is attached to the ceiling and blows wind in one direction. For example, the air conditioner 1000 may include an air conditioner (hereinafter referred to as a 4-way ceiling-mounted air conditioner) that blows wind in four directions, a stand-alone air conditioner, and/or a wall-mounted air conditioner. However, for convenience of description, in the disclosure, a case where the air conditioner 1000 is a 1-way ceiling-mounted air conditioner is used as an example.

The air conditioner 1000 according to an embodiment of the disclosure may include a radar sensor 1001, instead of a passive infrared (PIR) sensor, for human detection. The radar sensor 1001 may identify a location, speed, and direction of an object by using electromagnetic waves. For example, the radar sensor 1001 may transmit electromagnetic waves through a transceiver antenna and analyze electromagnetic waves reflected after the electromagnetic waves collide with the object. The radar sensor 1001 may detect a distance from the object and a direction and speed of the object based on the time required for the electromagnetic waves to be reflected.

According to an embodiment of the disclosure, the air conditioner 1000 may detect a person by using the radar sensor 1001. For example, the air conditioner 1000 may detect the presence of a person or a location of a person by using the radar sensor 1001. The person may include, but is not limited to, a person or a companion animal that resides or is present in an indoor space (e.g., home, office, etc.) where the air conditioner 1000 is positioned. The person may also be expressed as a user, a consumer, or a resident.

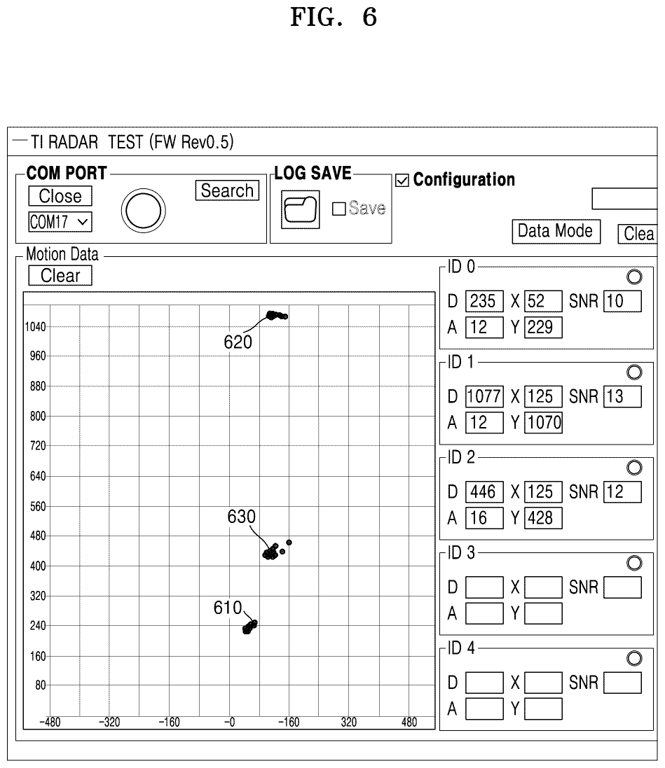

According to an embodiment of the disclosure, the air conditioner 1000 may also detect one or more people by using the radar sensor 1001. For example, the air conditioner 1000 may detect a plurality of people and track locations of the plurality of people via the radar sensor 1001. An operation of the air conditioner 1000 to track the locations of the plurality of people by using the radar sensor 1001 is described in detail below with reference to FIG. 6.

According to an embodiment of the disclosure, the air conditioner 1000 may accurately identify a location and movement of a person by using the radar sensor 1001, and thus, the operation of the air conditioner 1000 may be efficiently controlled based on the location and the movement of the person. For example, the air conditioner 1000 may adaptively control wind volume (wind speed) according to an activity level of the person or the number of people. Also, the air conditioner 1000 may finely adjust a wind direction according to a mode (e.g., a direct wind mode or an indirect wind mode) set by the person and the location of the person.

According to an embodiment of the disclosure, the air conditioner 1000 may also detect the absence of a person by using the radar sensor 1001 and perform operations to save energy when the person is absent. Also, the air conditioner 1000 may also use the radar sensor 1001 to detect unintended movement of the person at home while the person is out, and transmit a security sensing notification to a user terminal. The air conditioner 1000 may also identify the health state (e.g., activity level, heart rate, respiration rate, etc.) of the person by using the radar sensor 1001 and output a notification related to the health state of the person.

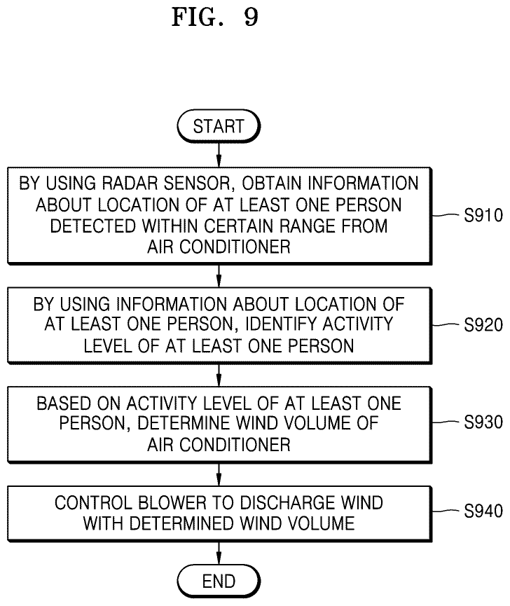

That is, according to an embodiment of the disclosure, the air conditioner 1000 may provide comfort, energy saving, convenience, and stability to the person by using the radar sensor 1001. An operation of the air conditioner 1000 to use the radar sensor 1001 is described in detail below with reference to FIGS. 9 to 25.

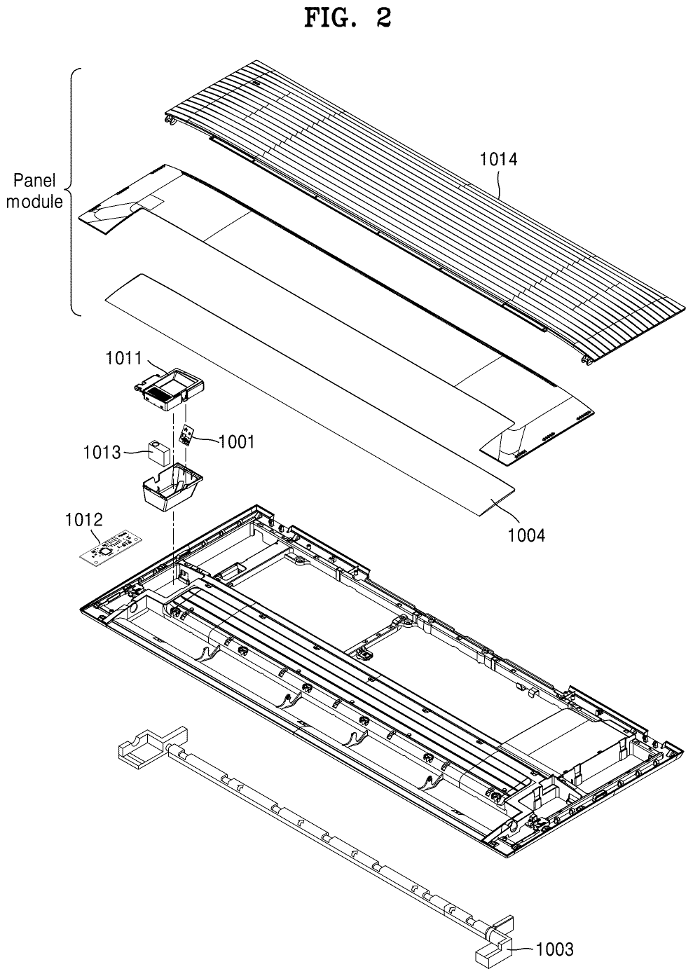

Hereinafter, the radar sensor 1001 is described in detail with reference to FIG. 2.

FIG. 2 is a diagram to describe the radar sensor 1001 according to an embodiment of the disclosure.

According to an embodiment of the disclosure, the radar sensor 1001 may be provided inside an indoor unit main body to face a floor surface. The radar sensor 1001 is positioned inside the indoor unit main body and thus may not be visible from the outside.

According to an embodiment of the disclosure, the radar sensor 1001 may be arranged on one side of the air conditioner 1000. For example, the radar sensor 1001 may be arranged on the left side or right side of a blade 1004. Also, the radar sensor 1001 may be arranged near a remote control receiver. The remote control receiver may include an IR communication module.

The radar sensor 1001 may be connected to a processor included in a printed board assembly (PBA) or printed circuit board assembly 1012. The radar sensor 1001 may communicate with the processor at a certain period. The radar sensor 1001 may transmit information about the presence of a person to the processor at a certain period. For example, when a person is detected, the radar sensor 1001 may transmit information (e.g., coordinate values) about a location of the person to the processor. When a plurality of people are detected, the radar sensor 1001 may transmit information about a location of each of the plurality of people to the processor. Also, when the person leaves a detection area, the radar sensor 1001 may transmit information about the absence of the person to the processor.

In FIG. 2, a case where one radar sensor 1001 is provided in the air conditioner 1000 is shown as an example, but the disclosure is not limited thereto. The air conditioner 1000 may also include a plurality of radar sensors 1001. For example, when the air conditioner 1000 is a 4-way ceiling-mounted air conditioner, the air conditioner 1000 may include two radar sensors 1001. A first radar sensor may be provided on the left side of the air conditioner 1000 to face a left floor surface, and a second radar sensor may be provided on the right side of the air conditioner 1000 to face a right floor surface.

In addition, according to an embodiment of the disclosure, in order to expand the detection area, the radar sensor 1001 may be arranged to be tilted at a preset angle (e.g., about 50° to about) 70° and directed toward the floor surface. For example, when the air conditioner 1000 is a 1-way ceiling-mounted air conditioner, the radar sensor 1001 may be arranged to be tilted at an angle of about 50° to about 70° from a panel module and directed toward the floor surface, instead of being installed horizontally with the panel module. Therefore, according to an embodiment of the disclosure, the indoor unit main body may include a sensor mounting portion 1011 on which the radar sensor 1001 is mounted to be tilted at a preset angle and directed toward the floor surface. The sensor mounting portion 1011 may also be expressed as a case sensor. In addition, the radar sensor 1001 arranged in the sensor mounting portion 1011 may be covered with a cover case. The sensor mounting portion 1011 may include, but is not limited to, a dust sensor 1013 in addition to the radar sensor 1001.

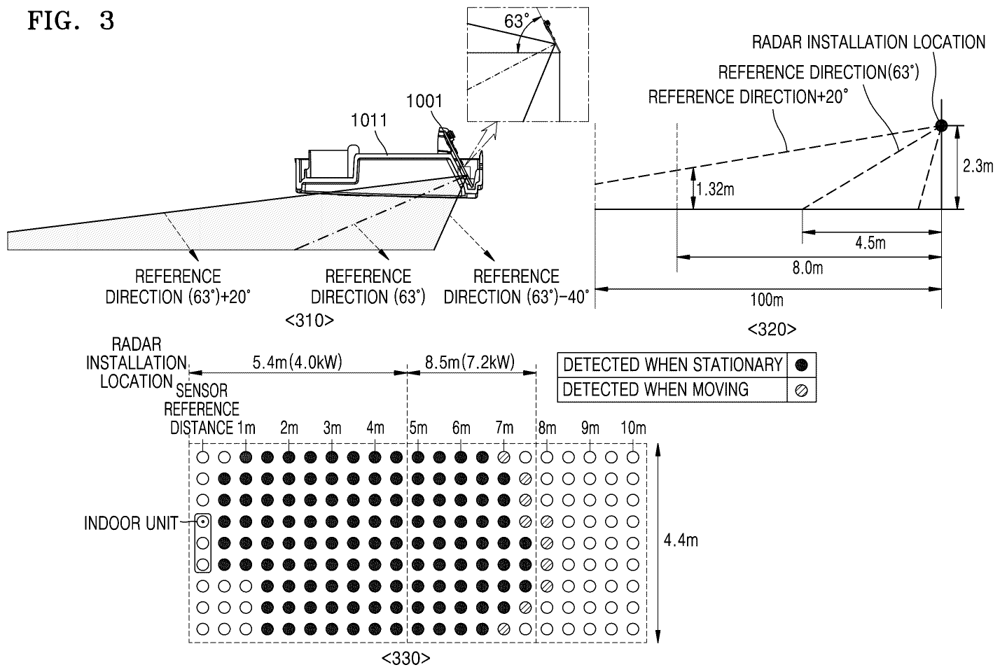

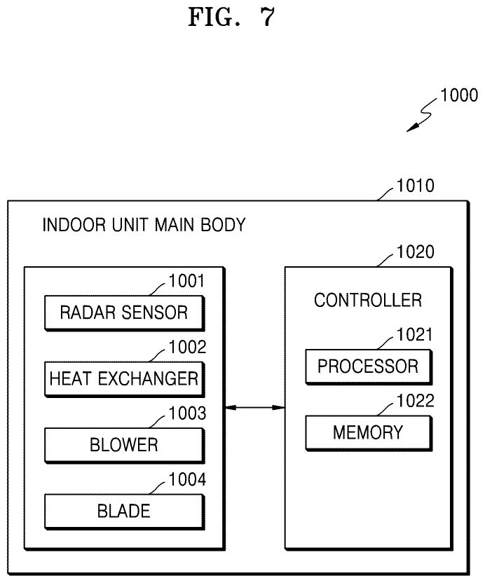

Moreover, the indoor unit main body may include an intake port (cover panel) 1014, a blower 1003, and the blade 1004. The configuration of the indoor unit main body is described in detail below with reference to FIG. 7, and an installation angle of the radar sensor 1001 is described in further detail with reference to FIG. 3.

FIG. 3 is a diagram to describe an installation angle of the radar sensor 1001 according to an embodiment of the disclosure.

Referring to 310 of FIG. 3, when the air conditioner 1000 is a 1-way ceiling-mounted air conditioner, instead of installing the radar sensor 1001 horizontally with the indoor unit main body, the radar sensor 1001 may be installed at an angle of 63° to expand the detection area. In this case, the indoor unit main body may include the sensor mounting portion 1011 that allows the radar sensor 1001 to be tilted at an angle of 63°. However, in this case, the angle of 63° is only an example, and the disclosure is not limited thereto.

Referring to 320 and 330 of FIG. 3, it may be identified that when the radar sensor 1001 is installed at an angle of 63°, a detection distance of the radar sensor 1001 reaches a maximum of 8 m. That is, when the radar sensor 1001 is installed at an angle of 63°, the detection area of the radar sensor 1001 may sufficiently cover the entire living room of a typical apartment house (e.g., 84 m²). Accordingly, the air conditioner 1000 may identify a location of a person via the radar sensor 1001 no matter where the person moves in the living room.

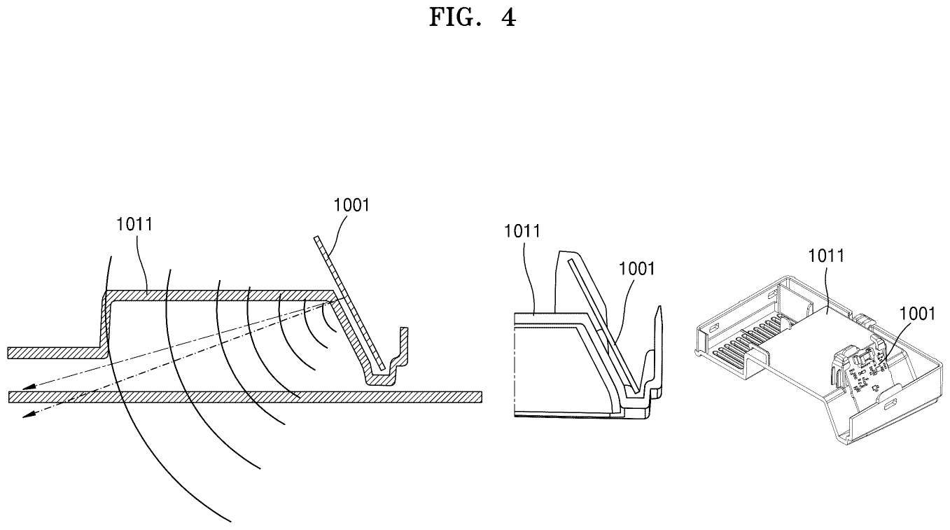

Hereinafter, the sensor mounting portion 1011 that allows the radar sensor 1001 to be tilted at an angle of 63° is described in more detail with reference to FIG. 4.

FIG. 4 is a diagram to describe the sensor mounting portion 1011 according to an embodiment of the disclosure.

Referring to FIG. 4, the sensor mounting portion 1011 may be designed with a structure that minimizes radio interference of the radar sensor 1001. For example, the sensor mounting portion 1011 may have a minimized structure in a radio wave path of the radar sensor 1001. That is, the interior of an injection-molded product that forms the sensor mounting portion 1011 may be designed as an empty space.

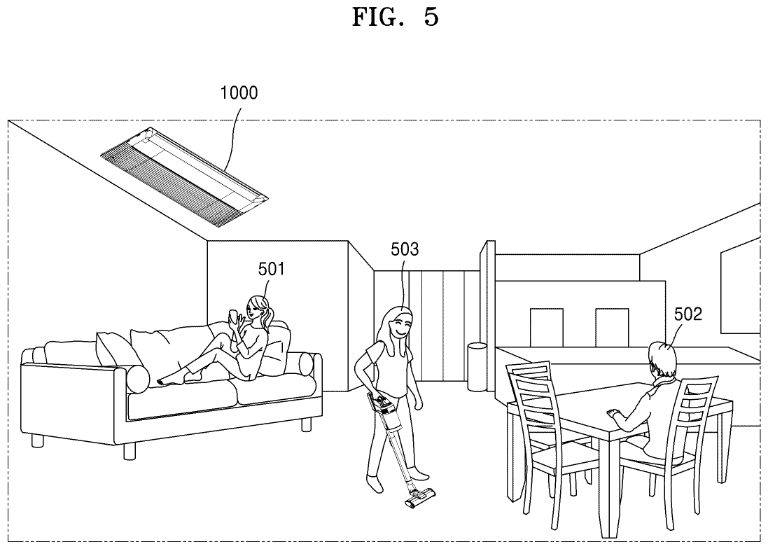

In addition, the radar sensor 1001 mounted on the sensor mounting portion 1011 may detect a plurality of people. Referring to FIGS. 5 and 6, an operation of the radar sensor 1001 to detect a plurality of people is described.

FIG. 5 is a diagram to describe an operation of detecting a plurality of people via the radar sensor 1001, according to an embodiment of the disclosure.

Referring to FIG. 5, a plurality of people may be located in a detection area of the radar sensor 1001 included in the air conditioner 1000. For example, a first person 501, a second person 502, and a third person 503 may be located in the detection area of the radar sensor 1001. When the power of the air conditioner 1000 is turned on and the radar sensor 1001 is activated, the radar sensor 1001 may transmit electromagnetic waves and detect each of the first person 501, the second person 502, and the third person 503.

According to an embodiment of the disclosure, the radar sensor 1001 may identify a location, movement, etc. of each of the plurality of people. For example, the radar sensor 1001 may identify each of a location of the first person 501, a location of the second person 502, and a location of the third person 503 and transmit, to the processor, a location value of the first person 501, a location value of the second person 502, and a location value of the third person 503. An operation of the radar sensor 1001 to identify locations of the plurality of people is described in further detail with reference to FIG. 6.

FIG. 6 is a diagram to describe coordinates of a plurality of people detected via the radar sensor 1001, according to an embodiment of the disclosure.

Referring to FIG. 6, the air conditioner 1000 may obtain a location of a person as coordinates on a plane by using the radar sensor 1001. For example, when the first person 501, the second person 502, and the third person 503 are located in the detection area of the radar sensor 1001, the air conditioner 1000 may use the radar sensor 1001 to obtain a first coordinate value 610 as the location value of the first person 501, a second coordinate value 620 as the location value of the second person 502, and a third coordinate value 630 as the location value of the third person 503.

In addition, the air conditioner 1000 may track the location of the person by using the radar sensor 1001. Accordingly, when the person moves, the air conditioner 1000 may identify a direction of the movement. Also, the air conditioner 1000 may use the radar sensor 1001 to determine whether the person is close to or far from the air conditioner 1000, moving, or absent.

Unlike a PIR sensor, the radar sensor 1001 may detect all movements within the detection area, thereby accurately controlling the operation of the air conditioner 1000. In particular, when the radar sensor 1001 is used, the location of the person may be detected in units of cm (or inches), and thus, the air conditioner 1000 may perform precise control based on the location of the person.

FIG. 7 is a block diagram to describe functions of the air conditioner 1000 according to an embodiment of the disclosure.

Referring to FIG. 7, an indoor unit main body 1010 of the air conditioner 1000 may include the radar sensor 1001, a heat exchanger 1002, the blower 1003, the blade 1004, and a controller 1020, but at least one of the components shown in FIG. 7 may not be an essential component. The indoor unit main body 1010 may be implemented with more components than those shown in FIG. 7 or the indoor unit main body 1010 may be implemented with fewer components.

The heat exchanger 1002 may exchange heat between a refrigerant and indoor air by using a phase change (e.g., evaporation or condensation) of the refrigerant. For example, the heat exchanger 1002 may evaporate a refrigerant in a wet vapor state by absorbing heat from the indoor air during cooling operation, and condense a refrigerant in a superheated vapor state by releasing heat to the indoor air during heating operation. The heat exchanger 1002 included in the indoor unit main body 1010 may be expressed as an indoor heat exchanger.

The blower 1003 may include an indoor fan and a fan motor. The indoor fan may include an axial fan, a radial fan, a crossflow fan, or a centrifugal fan. The blower 1003 may adjust the speed (volume) of discharged wind. The blower 1003 may reduce the speed (volume) of wind discharged from an outlet by reducing revolutions per minute (RPM), or may increase the speed (volume) of wind discharged from the outlet by increasing the RPM.

The blade 1004 is provided to adjust a direction of the discharged wind. The blade 1004 may also be expressed as a wind control plate. The blade 1004 may rotate around a rotation axis and adjust the direction of the discharged wind in a left-right direction or an up-down direction. The blade 1004 may include a horizontal blade that adjusts a wind direction of air discharged from the outlet up and down, and a vertical blade that adjusts the wind direction left and right. The horizontal blade may be elongated in a horizontal direction to control the opening and closing of the outlet and exposed at the front of the outlet, and may rotate around the rotation axis to control the flow of air discharged from the outlet in the up-down direction. A plurality of vertical blades may be formed in a vertical direction and may rotate around the rotation axis to control the flow of air discharged from the outlet in the left-right direction. The blade 1004 may be operated by a motor (not shown) that rotates in both a forward direction and a reverse direction.

The controller 1020 may include a memory 1022 that stores a program and/or data for controlling the air conditioner 1000, and a processor 1021 that outputs a control signal for controlling a load (e.g., the radar sensor 1001, the heat exchanger 1002, the blower 1003, the blade 1004, or the like) according to the program and/or data stored in the memory 1022.

The processor 1021 controls all operations of the air conditioner 1000. The processor 1021 may control components of the air conditioner 1000 by executing the program stored in the memory 1022.

The air conditioner 1000 may include one processor 1021 or a plurality of processors 1021. The processor 1021 may include at least one of a central processing unit (CPU), a GPU, an accelerated processing unit (APU), a many integrated core (MIC), a digital signal processor (DSP), or an NPU. The at least one processor 1021 may be implemented as a SoC including one or more electronic components. Each of the at least one processor 1021 may also be implemented as separate hardware (H/W). The at least one processor 1021 may also be expressed as a microcomputer (MICOM), a microprocessor computer, a microprocessor controller, an MPU, or a microcontroller unit (MCU).

According to the disclosure, the at least one processor 1021 may be implemented as a single core processor or may be implemented as a multicore processor.

The memory 1022 stores or records various types of information, data, instructions, programs, etc. necessary for the operation of the air conditioner 1000. The memory 1022 may store temporary data generated during a process of generating a control signal for controlling components included in the air conditioner 1000. The memory 1022 may include at least one of volatile memory or nonvolatile memory or a combination thereof.

The memory 1022 may include at least one type of storage medium from among flash memory, hard disk, multimedia card micro memory, card type memory (e.g., secure digital (SD) or extreme digital (XD) memory), random access memory (RAM), static RAM (SRAM), read-only memory (ROM), electrically erasable programmable ROM (EEPROM), programmable ROM (PROM), magnetic memory, magnetic disk, or an optical disk. Programs stored in the memory 1022 may be classified into a plurality of modules according to functions thereof.

The processor 1021 and the memory 1022 may be provided as a single body or may be provided separately. The processor 1021 may include one or more processors. For example, the processor 1021 may include a main processor and at least one subprocessor. The memory 1022 may include one or more memories.

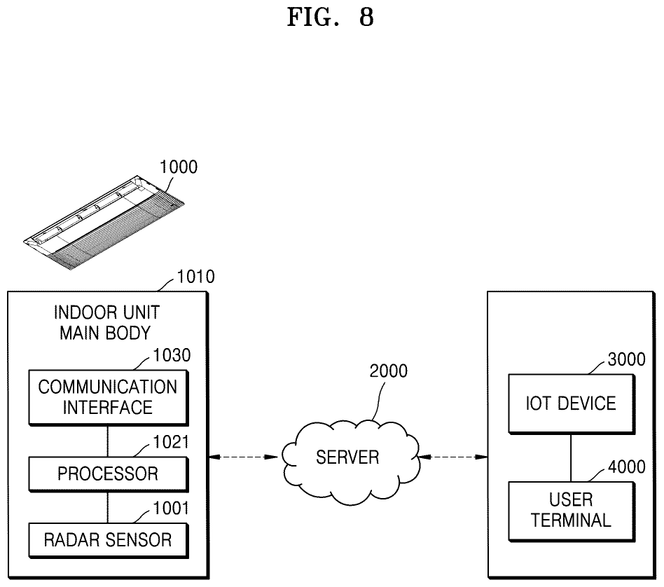

FIG. 8 is a diagram to describe a communication system of the air conditioner 1000 according to an embodiment of the disclosure.

Referring to FIG. 8, the indoor unit main body 1010 of the air conditioner 1000 may include a communication interface 1030. The communication interface 1030 may include a short-range communication interface, a long-range communication interface, or the like. The short-range communication interface may include, but is not limited to, a Bluetooth communication interface, a BLE communication interface, an NFC interface, a WLAN (e.g., Wi-Fi) communication interface, a ZigBee communication interface, an IrDA communication interface, a WFD communication interface, a UWB communication interface, or an Ant+ communication interface. The long-range communication interface may be used to allow the air conditioner 1000 to remotely communicate with a server 2000. The long-range communication interface may include the Internet, a computer network (e.g., a LAN or a WAN), a mobile communicator, etc. The mobile communicator may include, but is not limited to, a 3rd-generation (3G) module, a 4th-generation (4G) module, a 5th-generation (5G) module, a long term evolution (LTE) module, a narrowband Internet of things (NB-IoT) module, or an LTE-M module.

According to an embodiment of the disclosure, the communication interface 1030 of the air conditioner 1000 may communicate with the server 2000, an Internet-of-things (IoT) device 3000, and a user terminal 4000 via a network.

The server 2000 may include a communication module that may communicate with another server, the air conditioner 1000, the IoT device 3000, or the user terminal 4000, at least one processor that may process data received from another server, the air conditioner 1000, the IoT device 3000, or the user terminal 4000, and at least one memory that may store a program for processing data or processed data. The server 2000 may be implemented as various computing devices, such as a workstation, a cloud, a data drive, or a data station. The server 2000 may be implemented as one or more servers physically or logically separated based on functions, detailed configurations of functions, or data, and may transmit or receive data and process the transmitted or received data through communication between respective servers.

The server 2000 may perform functions, such as managing a user account, registering the air conditioner 1000, the IoT device 3000, and the user terminal 4000 in association with the user account, and managing or controlling the registered air conditioner 1000, IoT device 3000, and user terminal 4000. For example, a user may access the server 2000 through the user terminal 4000 and generate a user account. The user account may be identified based on an ID and a password set by the user. The server 2000 may register the air conditioner 1000 and the IoT device 3000 to the user account according to a set procedure. For example, the server 2000 may register, manage, and control the air conditioner 1000 and the IoT device 3000 by linking identification information (e.g., serial number or medium access control (MAC) address) about the air conditioner 1000 and the IoT device 3000 to the user account.

The IoT device 3000 may include a communication module that may communicate with the air conditioner 1000, the user terminal 4000, and/or the server 2000, a user interface that receives a user input or outputs information to a user, at least one processor that controls the operation of the IoT device 3000, and at least one memory storing a program for controlling the operation of the IoT device 3000.

The IoT device 3000 may be at least one of various types of home appliances. For example, the IoT device 3000 may include, but is not limited to, at least one of a dishwasher, an electric range, an electric oven, an air conditioner, a clothes manager, a washing machine, a drying machine, a microwave oven, an air purifier, a robot vacuum cleaner, a vacuum cleaner, or a television.

The user terminal 4000 may include a communication module that may communicate with the air conditioner 1000, the IoT device 3000, or the server 2000, a user interface that receives a user input or outputs information to a user, at least one processor that controls the operation of the user terminal 4000, and at least one memory storing a program for controlling the operation of the user terminal 4000.

The user terminal 4000 may be carried by a user or placed in a user's home or office. The user terminal 4000 may include, but is not limited to, a personal computer, a terminal, a portable telephone, a smartphone, a handheld device, or a wearable device. In the disclosure, the user terminal 4000 may also be expressed as a mobile terminal.

A program, that is, an application, for controlling the air conditioner 1000 and the IoT device 3000 may be stored in the memory of the user terminal 4000. The application may be installed on the user terminal 4000 and sold, or may be downloaded from an external server and installed.

The user may access the server 2000 by executing the application installed on the user terminal 4000, generate a user account, communicate with the server 2000 based on the logged-in user account, and register the air conditioner 1000 and the IoT device 3000.

For example, when the air conditioner 1000 and the IoT device 3000 are operated according to a procedure guided by the application installed on the user terminal 4000 such that the air conditioner 1000 and the IoT device 3000 may connect to the server 2000, the server 2000 may register the air conditioner 1000 and the IoT device 3000 to the user account by registering identification information (e.g., serial number or MAC address) about the air conditioner 1000 and the IoT device 3000 to the user account.

The user may control the air conditioner 1000 and the IoT device 3000 by using the application installed on the user terminal 4000. For example, when the user logs into the user account with the application installed on the user terminal 4000, the air conditioner 1000 and the IoT device 3000 registered to the user account may appear, and when the user inputs a control command for the air conditioner 1000 or the IoT device 3000, the control command may be transmitted to the air conditioner 1000 or the IoT device 3000 through the server 2000.

The network may include both a wired network and a wireless network. The wired network may include a cable network or a telephone network, and the wireless network may include any network that transmits and receives signals via radio waves. The wired network and the wireless network may be connected to each other.

The network may include a WAN such as the Internet, a LAN formed around an access point (AP), or a short-range wireless network that does not go through an AP. The short-range wireless network may include, but is not limited to, Bluetooth™ (IEEE 802.15.1), ZigBee (IEEE 802.15.4), WFD, NFC, or Z-wave.

The AP may connect the air conditioner 1000, the IoT device 3000, or the user terminal 4000 to a WAN to which the server 2000 is connected. The air conditioner 1000, the IoT device 3000, or the user terminal 4000 may be connected to the server 2000 via the WAN.

The AP may communicate with the air conditioner 1000, the IoT device 3000, or the user terminal 4000 by using wireless communication, such as Wi-Fi™ (IEEE 802.11), Bluetooth™ (IEEE 802.15.1), or ZigBee (IEEE 802.15.4) and connect to the WAN by using wired communication, but is not limited thereto.

According to an embodiment of the disclosure, the air conditioner 1000 may be directly connected to the user terminal 4000, the IoT device 3000, or the server 2000 without going through an AP.

The air conditioner 1000 may be connected to the IoT device 3000, the user terminal 4000, or the server 2000 via a long-range wireless network or a short-range wireless network. For example, the air conditioner 1000 may be connected to the user terminal 4000 via the short-range wireless network (e.g., WFD).

The air conditioner 1000 may also be connected to the user terminal 4000, the server 2000, or the IoT device 3000 via the WAN by using the long-range wireless network (e.g., a cellular communication module). Also, the air conditioner 1000 may access the WAN by using wired communication and be connected to the user terminal 4000, the server 2000, or the IoT device 3000 via the WAN.

When the air conditioner 1000 may connect to the WAN by using wired communication, the air conditioner 1000 may also operate as an AP. Accordingly, the air conditioner 1000 may connect the IoT device 3000 to the WAN to which the server 2000 is connected. Also, the IoT device 3000 may connect the air conditioner 1000 to the WAN to which the server 2000 is connected.

The air conditioner 1000 may transmit information about the operation or state of the air conditioner 1000 to the IoT device 3000, the user terminal 4000, or the server 2000 via a network. For example, when a request is received from the server 2000, when a specific event occurs in the air conditioner 1000, or periodically or in real time, the air conditioner 1000 may transmit the information about the operation or state of the air conditioner 1000 to the IoT device 3000, the user terminal 4000, or the server 2000. When the information about the operation or state of the air conditioner 1000 is received from the air conditioner 1000, the server 2000 may update stored information about the operation or state of the air conditioner 1000 and transmit the updated information about the operation or state of the air conditioner 1000 to the user terminal 4000 via a network. In this case, information updating may include various operations that change existing information, such as adding new information to existing information or replacing existing information with new information.

The air conditioner 1000 may obtain various types of information from the IoT device 3000, the user terminal 4000, or the server 2000 and provide the obtained information to a user. For example, the air conditioner 1000 may obtain, from the server 2000, information related to functions of the air conditioner 1000 and various types of environmental information (e.g., weather, temperature, humidity, etc.) and output the obtained information through a user interface.

The air conditioner 1000 may operate according to a control command received from the IoT device 3000, the user terminal 4000, or the server 2000. For example, when the air conditioner 1000 obtains prior approval from a user to operate according to a control command from the server 2000 even without a user input, the air conditioner 1000 may operate according to the control command received from the server 2000. In this case, the control command received from the server 2000 may include, but is not limited to, a control command input by the user through the user terminal 4000 or a control command based on a preset condition.

The user terminal 4000 may transmit information about the user to the air conditioner 1000, the IoT device 3000, or the server 2000 through a communication module. For example, the user terminal 4000 may transmit, to the server 2000, information about a location of the user, health state of the user, preferences of the user, a schedule of the user, etc. The user terminal 4000 may transmit, to the air conditioner 1000 or the server 2000, information about the user according to prior approval from the user.

The air conditioner 1000, the IoT device 3000, the user terminal 4000, or the server 2000 may determine a control command by using technology such as artificial intelligence (AI). For example, the server 2000 may receive information about the operation or state of the air conditioner 1000 and the IoT device 3000 or receive information about a user of the user terminal 4000, process the information by using technology such as AI, and transmit a result of the processing or a control command to the air conditioner 1000, the IoT device 3000, or the user terminal 4000 based on the result of the processing.

Hereinafter, an operation of the air conditioner 1000 to provide a service customized to a person based on a location of the person by using the radar sensor 1001 is described in detail with reference to FIGS. 9 to 25.

FIG. 9 is a flowchart to describe a method for the air conditioner 1000 to control wind volume, according to an embodiment of the disclosure.

Referring to FIG. 9, the method for the air conditioner 1000 to control wind volume may include operations S910 to S940. According to an embodiment of the disclosure, operations S910 to S940 may be executed by at least one processor included in the air conditioner 1000. The method for the air conditioner 1000 to control wind volume is not limited to that shown in FIG. 9, and in one or more embodiments, operations not shown in FIG. 9 may be further included or some operations may be omitted.

In operation S910, according to an embodiment of the disclosure, the air conditioner 1000 may obtain information about a location of at least one person detected within a certain range from the air conditioner 1000.

According to an embodiment of the disclosure, when a user turns on the power of the air conditioner 1000, the air conditioner 1000 may use the radar sensor 1001 to detect at least one person and obtain a location of the at least one person. For example, the radar sensor 1001 may transmit electromagnetic waves, analyze a signal reflected from the person, and obtain coordinates in a detection area corresponding to a current location of the person. The radar sensor 1001 may transmit, to the processor 1021, coordinates corresponding to the current location of the person. Accordingly, information about the location of the at least one person may include a coordinate value corresponding to the current location of the person.

According to an embodiment of the disclosure, even when the person moves, the air conditioner 1000 may track the location of the person by using the radar sensor 1001. For example, the processor 1021 of the air conditioner 1000 may identify a change in coordinates of the person received from the radar sensor 1001.

In operation S920, according to an embodiment of the disclosure, the air conditioner 1000 may identify an activity level of the at least one person by using the information about the location of the at least one person.

According to an embodiment of the disclosure, the air conditioner 1000 may detect movement of the person based on a change in coordinates measured by the radar sensor 1001. For example, the air conditioner 1000 may identify the activity level of the person by calculating a distance by which the person moves per second based on the change in coordinates of the person measured by the radar sensor 1001. The air conditioner 1000 may identify that the greater the distance by which the person moves per second, the greater the activity level of the person, and may identify that the smaller the distance by which the person moves per second, the lower the activity level of the person.

In operation S930, according to an embodiment of the disclosure, the air conditioner 1000 may determine wind volume of the air conditioner 1000 based on the activity level of the at least one person.

According to an embodiment of the disclosure, the air conditioner 1000 may determine the activity level of the at least one person to be higher as the wind volume (wind speed) of the air conditioner 1000 is high, and may determine the activity level of the at least one person to be lower as the wind volume is low. For example, the air conditioner 1000 may determine that the wind volume (wind speed) is set to high when the activity level of the at least one person is determined to be higher according to the movement of the person, which is based on the change in coordinates measured by the radar sensor 1001. Also, the air conditioner 1000 may determine that the wind volume (wind speed) is set to low when the activity of the at least one person is determined to be low according to the lack of movement by the person, which is based on based on the lack of change (e.g., minimum change) in coordinates measured by the radar sensor 1001.

According to an embodiment of the disclosure, a table defining the activity level of the person and the level of wind volume (wind speed) may be stored in the memory 1022 of the air conditioner 1000. For example, the air conditioner 1000 may store, in the memory 1022, a table in which the activity level of the person is defined as a number between 0 and 10 and the number is matched with a wind volume mode according to the activity level of the person. In this case, the processor 1021 of the air conditioner 1000 may determine wind volume according to the activity level of the person, based on the table stored in the memory 1022.

For example, the air conditioner 1000 may determine the wind volume as gentle wind when the activity level of the person is 0 to 3, determine the wind volume as weak wind when the activity level of the person is 4 to 6, determine the wind volume as strong wind when the activity level of the person is 7 or 8, and determine the wind volume as turbo wind when the activity level of the person is 10.

In operation S940, according to an embodiment of the disclosure, the air conditioner 1000 may control the blower 1003 to discharge wind with the wind volume determined in operation S930.

For example, when the wind volume corresponding to the activity level of the person is “weak wind”, the air conditioner 1000 may adjust an RPM of the blower 1003 to an RPM corresponding to the weak wind. When the wind volume corresponding to the activity level of the person is “strong wind”, the air conditioner 1000 may adjust the RPM of the blower 1003 to an RPM corresponding to the strong wind.

Therefore, according to an embodiment of the disclosure, the air conditioner 1000 may identify the activity level of the person by using the radar sensor 1001, and when the activity level of the person is high, may increase the wind volume such that an indoor temperature may quickly reach a set temperature (desired temperature).

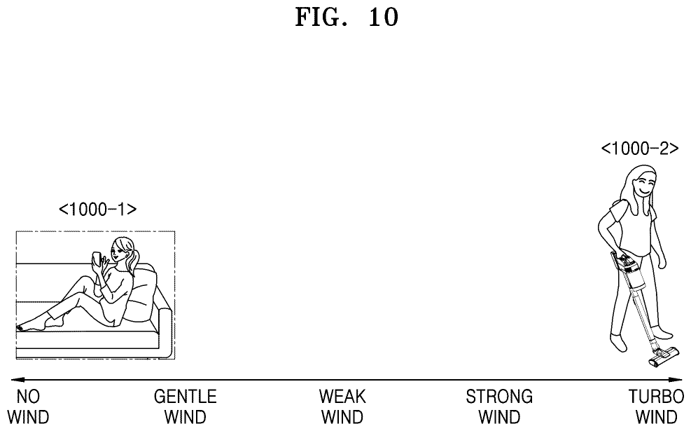

FIG. 10 is a diagram to describe an operation of the air conditioner 1000 to control wind volume, according to an embodiment of the disclosure.

Referring to view 1000-1 of FIG. 10, a user may turn on the air conditioner 1000, sit on a sofa, and watch a video on a smartphone. In this case, the air conditioner 1000 may detect movement of the user via the radar sensor 1001 and calculate a distance by which the user moves per second in real time, thereby identifying an activity level of the user. Because the user is sitting on the sofa, the distance by which the user moves per second may be close to 0. Accordingly, because the activity level of the user is close to 0, the air conditioner 1000 may determine the wind volume as gentle wind and adjust the RPM of the blower 1003 to an RPM corresponding to the gentle wind.

Referring to view 1000-2 of FIG. 10, the user may turn on the air conditioner 1000 and clean a room by using a stick vacuum cleaner. In this case, the air conditioner 1000 may detect movement of the user via the radar sensor 1001 and calculate a distance by which the user moves per second in real time, thereby identifying the activity level of the user. Because the user is constantly moving to clean a room, the distance by which the user moves per second may be long. That is, because the activity level of the user is considerably high, the air conditioner 1000 may determine the wind volume as turbo wind and adjust the RPM of the blower 1003 to an RPM corresponding to the turbo wind. Accordingly, the user may finish cleaning in a cooler and more pleasant environment.

Referring to FIG. 10, the air conditioner 1000 may switch between wind volume modes in the order of a windless mode, a gentle wind mode, a weak wind mode, a strong wind mode, and a turbo wind mode as the activity level of the user increases. In contrast, the air conditioner 1000 may switch between wind volume modes in the order of the turbo wind mode, the strong wind mode, the weak wind mode, the gentle wind mode, and the windless mode as the activity level of the user decreases. Therefore, according to an embodiment of the disclosure, the air conditioner 1000 may adjust the wind volume (wind speed) based on the activity level of the user, thereby allowing the user to carry out activities in a more pleasant environment.

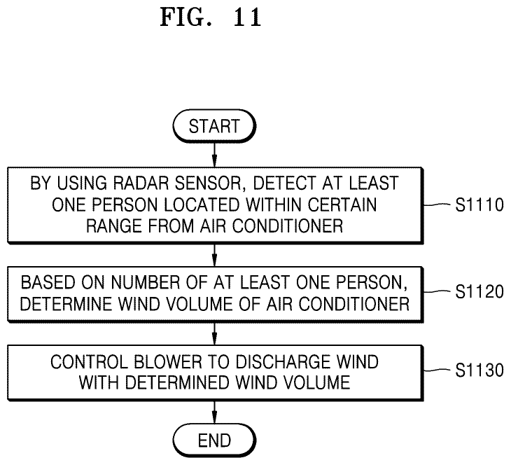

FIG. 11 is a flowchart to describe a method for the air conditioner 1000 to control wind volume according to the number of people, according to an embodiment of the disclosure.

Referring to FIG. 11, the method for the air conditioner 1000 to control wind volume according to the number of people may include operations S1110 to S1130. According to an embodiment of the disclosure, operations S1110 to S1130 may be executed by at least one processor included in the air conditioner 1000. The method for the air conditioner 1000 to control wind volume according to the number of people is not limited to that shown in FIG. 11, and in one or more embodiments, operations not shown in FIG. 11 may be further included or some operations may be omitted.

In operation S1110, according to an embodiment of the disclosure, the air conditioner 1000 may use the radar sensor 1001 to detect at least one person located within a certain range from the air conditioner 1000.

According to an embodiment of the disclosure, when a user turns on the power of the air conditioner 1000, the air conditioner 1000 may detect at least one person by using the radar sensor 1001. In this case, the radar sensor 1001 may also detect a plurality of people.

For example, the processor 1021 of the air conditioner 1000 may receive, when one person is present within a detection area of the radar sensor 1001, a coordinate value of the one person from the radar sensor 1001, and may receive, when three people are present within the detection area of the radar sensor 1001, coordinate values of the respective three people from the radar sensor 1001.

In operation S1120, according to an embodiment of the disclosure, the air conditioner 1000 may determine wind volume of the air conditioner 1000 based on the number of at least one person.

According to an embodiment of the disclosure, the air conditioner 1000 may determine the wind volume (wind speed) of the air conditioner 1000 to be higher as the number of people detected by the radar sensor 1001 is large, and may determine the wind volume to be lower as the number of people detected by the radar sensor 1001 is small.

According to an embodiment of the disclosure, a table defining the number of people and the level of wind volume (wind speed) may be stored in the memory 1022 of the air conditioner 1000. In this case, the processor 1021 of the air conditioner 1000 may determine wind volume according to the number of people, based on the table stored in the memory 1022.

For example, the air conditioner 1000 may determine the wind volume as gentle wind when the number of people is 1, determine the wind volume as weak wind when the number of people is 2, determine the wind volume as strong wind when the number of people is 3, and determine the wind volume as turbo wind when the number of people is 4.

In operation S1130, according to an embodiment of the disclosure, the air conditioner 1000 may control the blower 1003 to discharge wind with the wind volume determined in operation S1120.

For example, when the wind volume corresponding to the number of people is “gentle wind”, the air conditioner 1000 may adjust an RPM of the blower 1003 to an RPM corresponding to the gentle wind. When the wind volume corresponding to the number of people is “strong wind”, the air conditioner 1000 may adjust the RPM of the blower 1003 to an RPM corresponding to the strong wind.

Therefore, according to an embodiment of the disclosure, the air conditioner 1000 may identify the number of people by using the radar sensor 1001 and adjust the wind volume to a higher level as the number of people is large, such that the indoor temperature may quickly reach a set temperature (desired temperature).

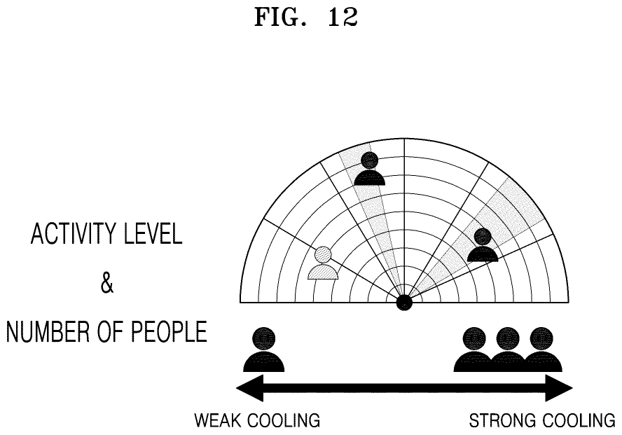

FIG. 12 is a diagram to describe an operation of the air conditioner 1000 to control wind volume according to the number of people and an activity level of each person, according to an embodiment of the disclosure.

According to an embodiment of the disclosure, the air conditioner 1000 may use the radar sensor 1001 to obtain the number of people and the activity level of each person, and adaptively adjust the wind volume in consideration of both the number of people and the activity level of each person. For example, the air conditioner 1000 may determine the wind volume to be higher as the number of people is large and the activity level of each person is high, and may determine the wind volume to be lower as the number of people is small and the activity level of each person is low.

Therefore, according to an embodiment of the disclosure, the air conditioner 1000 may provide a pleasant cooling environment to people by automatically adjusting the wind volume according to the number of people and the activity level of each person.

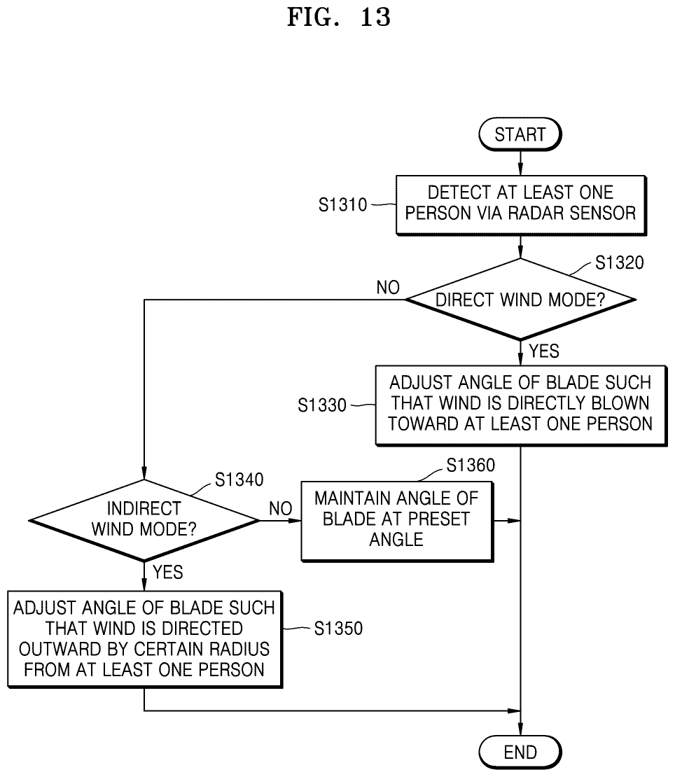

FIG. 13 is a diagram to describe a method for the air conditioner 1000 to adjust an angle of the blade 1004 based on a location of a person, according to an embodiment of the disclosure.

Referring to FIG. 13, the method for the air conditioner 1000 to adjust an angle of the blade 1004 based on a location of a person may include operations S1310 to S1360. According to an embodiment of the disclosure, operations S1310 to S1360 may be executed by at least one processor included in the air conditioner 1000. The method for the air conditioner 1000 to adjust an angle of the blade 1004 based on a location of a person is not limited to that shown in FIG. 13, and in one or more embodiments, operations not shown in FIG. 13 may be further included or some operations may be omitted.

In operation S1310, according to an embodiment of the disclosure, the air conditioner 1000 may detect at least one person via the radar sensor 1001. For example, when a person is present within a detection area of the radar sensor 1001, the processor 1021 of the air conditioner 1000 may receive information about a location of the at least one person from the radar sensor 1001.

In operation S1320, according to an embodiment of the disclosure, when at least one person is detected, the air conditioner 1000 may determine whether a currently set operation mode is a direct wind mode.

The direct wind mode may be a mode in which wind discharged from the air conditioner 1000 is directly blown toward the person. When the user wants the wind to be directly blown toward him or her, the user may set the direct wind mode by using an input interface of the air conditioner 1000 or the user terminal 4000. For example, the user may set the air conditioner 1000 to the direct wind mode by using a remote control of the air conditioner 1000. When the user selects the direct wind mode on the remote control, the remote control may transmit a command to set the air conditioner 1000 to the direct wind mode via infrared communication. Also, the user may select the direct wind mode by executing a specific application (e.g., a home appliance management application) on the user terminal 4000. In this case, the user terminal 4000 may transmit, to the server 2000, information that the user has selected the direct wind mode, and the server 2000 may transmit, to the air conditioner 1000, a command to set the direct wind mode.

In operation S1330, according to an embodiment of the disclosure, when the currently set operation mode is the direct wind mode (YES in S1320), the air conditioner 1000 may adjust the angle of the blade 1004 such that wind is directly blown toward the at least one person.

According to an embodiment of the disclosure, when the direct wind mode is set, the air conditioner 1000 may identify a location of the person by using the radar sensor 1001 and adjust a left-right angle of the blade 1004 (e.g., a vertical blade) such that wind is directly blown toward the person. For example, the air conditioner 1000 may adjust the angle of the blade 1004 to the left such that when the person is on the front left side of the air conditioner 1000, wind is discharged to the left, and may adjust the angle of the blade 1004 to the right such that when the person is on the front right side of the air conditioner 1000, wind is discharged to the right.

According to an embodiment of the disclosure, the air conditioner 1000 may also control the wind to be long wind or short wind by detecting a distance to the person or coordinates of the person. For example, the air conditioner 1000 may adjust an up-down angle of the blade 1004 (e.g., a horizontal blade) such that long wind is discharged when the person is far from the air conditioner 1000, and may adjust the up-down angle of the blade 1004 (e.g., a horizontal blade) such that short wind is discharged when the person is close to the air conditioner 1000. Therefore, according to an embodiment of the disclosure, when the direct wind mode is set, the air conditioner 1000 may track the location of the person regardless of whether the person is far from or close to the air conditioner 1000, and may automatically adjust the angle of the blade 1004 such that wind is directly blown toward the person. Also, even when the person moves, the air conditioner 1000 may track the location of the person and adaptively and finely adjust the up-down angle or the left-right angle of the blade 1004.

In addition, according to an embodiment of the disclosure, when a plurality of people are detected via the radar sensor 1001, the air conditioner 1000 may adjust the angle of the blade 1004 such that wind is alternately blown toward the plurality of people. For example, when a first person is on the front left side of the air conditioner 1000 and a second person is on the front right side of the air conditioner 1000, the angle of the blade 1004 may be adjusted such that wind stays on each of the first person and the second person for a preset period of time (e.g., 1 minute, 30 seconds, etc.). That is, when 1 minute has elapsed after the angle of the blade 1004 is adjusted to the left such that wind is blown toward the first person, the angle of the blade 1004 may be adjusted to the right such that wind is blown toward the second person. When another 1 minute has elapsed, the angle of the blade 1004 may be adjusted to the left such that wind is blown toward the first person, and when another 1 minute has elapsed, the angle of the blade 1004 may be adjusted to the right such that wind is blown toward the second person.

In operation S1340, according to an embodiment of the disclosure, when the currently set operation mode is not the direct wind mode (NO in S1320), the air conditioner 1000 may determine whether the currently set operation mode is an indirect wind mode.

The indirect wind mode may be a mode in which wind discharged from the air conditioner 1000 does not blow toward the person. When the user does not want the wind to be blown toward him or her, the user may set the indirect wind mode by using the input interface of the air conditioner 1000 or the user terminal 4000. For example, the user may set the air conditioner 1000 to the indirect wind mode by using a remote control of the air conditioner 1000. When the user selects the indirect wind mode on the remote control, the remote control may transmit a command to set the air conditioner 1000 to the indirect wind mode via infrared communication. Also, the user may select the indirect wind mode by executing a specific application (e.g., a home appliance management application) on the user terminal 4000. In this case, the user terminal 4000 may transmit, to the server 2000, information that the user has selected the indirect wind mode, and the server 2000 may transmit, to the air conditioner 1000, a command to set the indirect wind mode.

In operation S1350, according to an embodiment of the disclosure, when the currently set operation mode is the indirect wind mode (YES in S1340), the air conditioner 1000 may adjust the angle of the blade 1004 such that wind is directed outward by a certain radius (away) from the at least one person.

According to an embodiment of the disclosure, when the indirect wind mode is set, the air conditioner 1000 may identify the location of the person via the radar sensor 1001 and adjust the angle of the blade 1004 such that wind is discharged to a location where the person is not located. For example, the air conditioner 1000 may adjust the angle of the blade 1004 to the left such that when the person is on the right side of the air conditioner 1000, wind is discharged to the left, and may adjust the angle of the blade 1004 to the right such that when the person is on the left side of the air conditioner 1000, wind is discharged to the right.

According to an embodiment of the disclosure, even when the person moves, the air conditioner 1000 may track the location of the person via the radar sensor 1001 and adaptively adjust the angle of the blade 1004 such that wind is not directed toward the person.

In addition, according to an embodiment of the disclosure, when a plurality of people are detected via the radar sensor 1001, the air conditioner 1000 may adjust the angle of the blade 1004 such that wind is discharged to coordinates where none of the plurality of people are located. For example, when the first person is located on the front left side of the air conditioner 1000 and the second person is located on the front right side of the air conditioner 1000, the left-right angle of the blade 1004 (e.g., a vertical blade) may be adjusted such that wind is discharged to the front center of the air conditioner 1000, such that the wind is discharged away from both the first person and the second person. Also, when the first person and the second person are located near the air conditioner 1000, the up-down angle of the blade 1004 (e.g., a horizontal blade) may be adjusted such that wind is discharged far way.

In operation S1360, according to an embodiment of the disclosure, when the currently set operation mode is neither the direct wind mode nor the indirect wind mode (NO in S1340), the air conditioner 1000 may maintain the angle of the blade 1004 at a preset angle. That is, when the direct wind mode or the indirect wind mode is not set, the air conditioner 1000 may not adjust the angle of the blade 1004 according to the location of the person.

A human detection sensor (e.g., a PIR sensor) installed in a general air conditioner is unable to detect the exact location of the person. The human detection sensor (e.g., a PIR sensor) may only notify a processor (e.g., an MCU) of the presence of a person within a predefined area. Accordingly, the general air conditioner controls the airflow by dividing an area into two or more areas when a wind direction is controlled. Also, the human detection sensor (e.g., a PIR sensor) installed in the general air conditioner is unable to determine distance and is thus unable to identify whether a person is close to or far from a detection area. Accordingly, the general air conditioner requires a user to control a long wind or short wind function with a remote control, which is inconvenient.

However, according to an embodiment of the disclosure, when the user sets the indirect wind mode or the direct wind mode, the air conditioner 1000 may accurately identify the location of the person by using the radar sensor 1001 and may thus finely control the wind direction.

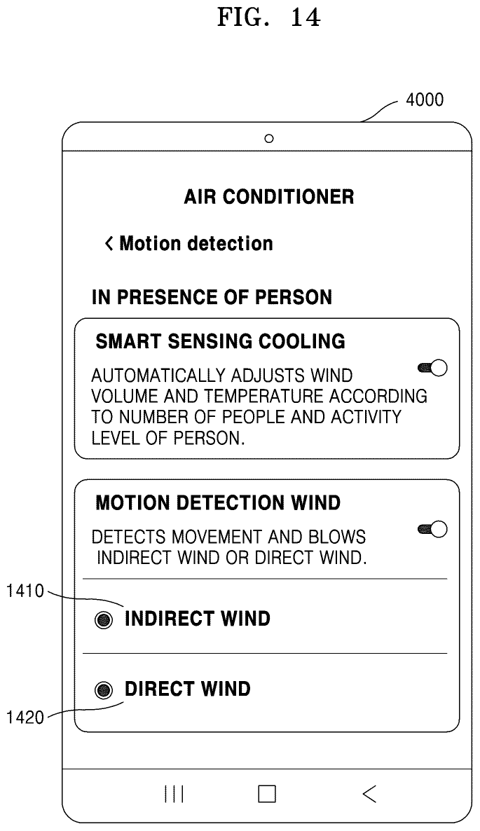

FIG. 14 is a diagram of a graphical user interface (GUI) for setting a direct wind mode or an indirect wind mode, according to an embodiment of the disclosure.

Referring to FIG. 14, a user may simply set an indirect wind mode or a direct wind mode by using the user terminal 4000. For example, the user may execute a specific application (e.g., a home appliance management application) on the user terminal 4000. In addition, the user may select indirect wind 1410 or direct wind 1420 according to the situation. For example, when the user exercises or cleans indoors, the user may select the direct wind 1420. Alternatively, when the user sleeps or sits and reads a book, the user may select the indirect wind 1410.

When the user selects the indirect wind 1410 or the direct wind 1420, the user terminal 4000 may transmit information about a user selection to the server 2000. In this case, the server 2000 may transmit, to the air conditioner 1000, a control command to set the indirect wind mode or the direct wind mode according to the user selection. The air conditioner 1000 may set the indirect wind mode or the direct wind mode in response to the control command from the server 2000 and continue to detect a location of the user by using the radar sensor 1001.

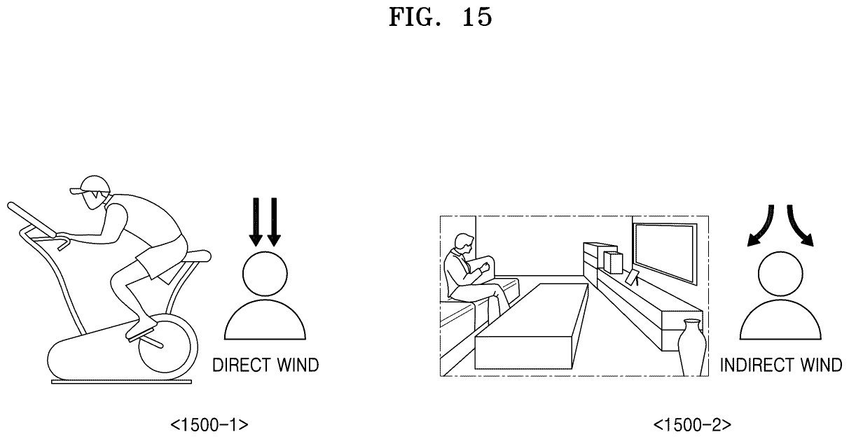

FIG. 15 is a diagram to describe an operation of the air conditioner 1000 to adjust an angle of a blade based on a location of a person, according to an embodiment of the disclosure.

Referring to view 1500-1 of FIG. 15, a user may set the air conditioner 1000 to the direct wind mode before riding an indoor bicycle. In addition, when the user rides the indoor bicycle, the air conditioner 1000 may identify a location of the user by using the radar sensor 1001 and adjust an angle of the blade 1004 such that wind is directly blown toward the user. Accordingly, the user may ride the indoor bicycle in a cool environment.

In addition, when the user finishes riding the indoor bicycle and then sits on a sofa, the air conditioner 1000 may track the location of the user and adjust the angle of the blade 1004 such that wind is directed toward the sofa.

Referring to view 1500-2 of FIG. 15, when the user does not want to be exposed to direct wind, the user may set the air conditioner 1000 to the indirect wind mode. When the user sets the indirect wind mode and then sits on the sofa and watches TV, the air conditioner 1000 may identify the location of the user and adjust the angle of the blade 1004 such that wind is not directed toward the sofa where the user is sitting.

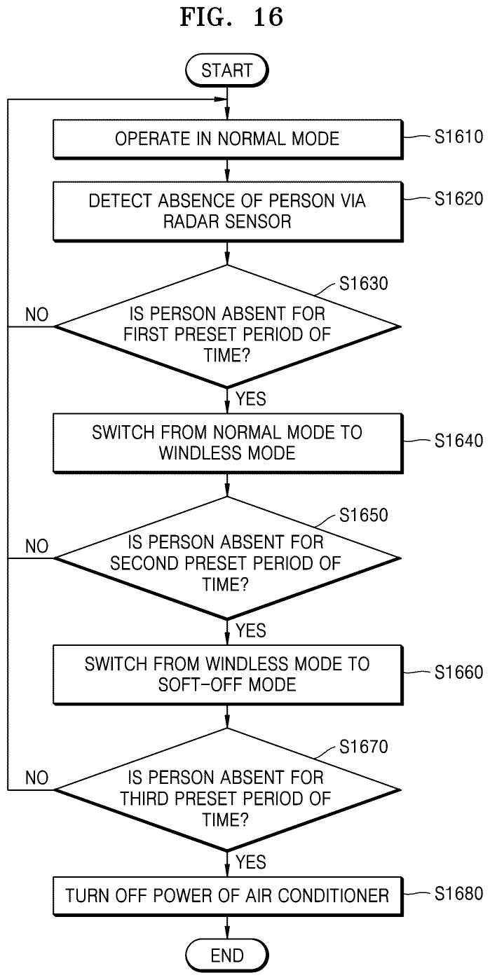

In addition, according to an embodiment of the disclosure, the air conditioner 1000 may detect the absence of the user by using the radar sensor 1001. Hereinafter, an operating method when the air conditioner 1000 detects the absence of the user is described in detail with reference to FIGS. 16 to 23.

FIG. 16 is a flowchart to describe a method for the air conditioner 1000 to operate in an energy saving mode when the absence of a person is detected, according to an embodiment of the disclosure.

Referring to FIG. 16, the method for the air conditioner 1000 to operate in an energy saving mode when the absence of a person is detected may include operations S1610 to S1680. According to an embodiment of the disclosure, operations S1610 to S1680 may be executed by at least one processor included in the air conditioner 1000. The method for the air conditioner 1000 to operate in an energy saving mode when the absence of a person is detected is not limited to that shown in FIG. 16, and in one or more embodiments, operations not shown in FIG. 16 may be further included or some operations may be omitted.

In operation S1610, according to an embodiment of the disclosure, when a person turns on the power of the air conditioner 1000, the air conditioner 1000 may operate in a normal mode.

The normal mode may be a mode that operates with a specific wind volume. In this case, the specific wind volume may be a wind volume selected by a user or a wind volume selected by the air conditioner 1000 according to the activity level of the person or the number of people. For example, the normal mode may be one of the gentle wind mode, the weak wind mode, the strong wind mode, or the turbo wind mode.

In operation S1620, according to an embodiment of the disclosure, the air conditioner 1000 may detect the absence of the person via the radar sensor 1001.

According to an embodiment of the disclosure, when the person goes out with the power of the air conditioner 1000 turned on, the air conditioner 1000 may identify, via the radar sensor 1001, that the person has left a detection area. When the person leaves the detection area, the radar sensor 1001 may no longer detect the location (movement) of the person. Accordingly, when location information (movement information) about the person is no longer received from the radar sensor 1001, the processor 1021 of the air conditioner 1000 may detect the absence of the person.

In operation S1630, according to an embodiment of the disclosure, the air conditioner 1000 may continue to determine whether the person is absent for a first preset period of time after the absence of the person is detected. For example, the air conditioner 1000 may continue to determine, via the radar sensor 1001, whether the person is absent for 60 minutes after the absence of the person is detected.

When the person is detected again via the radar sensor 1001 within the first preset period of time (e.g., 60 minutes) (NO in S1630), the air conditioner 1000 may continue to maintain the normal mode without switching to the energy saving mode. For example, when the user goes out for about 20 minutes with the air conditioner 1000 turned on and then returns home, the air conditioner 1000 may detect the absence of the person and then detect the person again after 20 minutes later. Accordingly, because the absence of the person was not maintained for the first preset period of time (e.g., 60 minutes), the air conditioner 1000 may continue to operate with a current wind volume without switching to the energy saving mode.

In operation S1640, according to an embodiment of the disclosure, when the absence of the person is detected via the radar sensor 1001 for the first preset period of time (YES in S1630), the air conditioner 1000 may switch an operation mode of the air conditioner 1000 from the normal mode to a windless mode, the normal mode operating with a specific wind volume.

The windless mode may be a mode in which the blade 1004 is closed and a windless panel (e.g., micro holes that generate slightly cold air) is used to create a pleasant room. The windless mode may be a mode that uses less electricity and allows the person to feel gentle coolness without being directly exposed.

According to an embodiment of the disclosure, when the absence of the person is maintained for the first preset period of time (e.g., 60 minutes), the air conditioner 1000 may switch from the normal mode to the windless mode to save energy. When switching to the windless mode, the air conditioner 1000 may close the blade 1004 and control the blower 1003 to reduce the wind volume (wind speed).

In operation S1650, according to an embodiment of the disclosure, the air conditioner 1000 may continue to determine whether the person is absent for a second preset period of time after switching to the windless mode. For example, the air conditioner 1000 may continue to determine, via the radar sensor 1001, whether the person is absent for 20 minutes after switching to the windless mode.

When the person is detected again via the radar sensor 1001 within the second preset period of time (e.g., 20 minutes) after switching to the windless mode (NO in S1650), the air conditioner 1000 may switch the windless mode to the normal mode with a specific wind volume. For example, when the user sets the air conditioner 1000 to the strong wind mode, goes out, and then returns home after 10 minutes have elapsed since the strong wind mode was switched to the windless mode, the air conditioner 1000 may deactivate the windless mode and operate in the strong wind mode again.

In operation S1660, according to an embodiment of the disclosure, when the absence of the person is continuously detected via the radar sensor 1001 for the second preset period of time after switching to the windless mode, the air conditioner 1000 may switch the windless mode to a soft-off mode in which a cooling operation stops. The soft-off mode may also be expressed as a standby mode.

The soft-off mode may be a mode in which the radar sensor 1001 and at least one processor 1021 remain activated, and the heat exchanger 1002, the blower 1003, and the blade 1004 are deactivated.

According to an embodiment of the disclosure, when the absence of the person is maintained for the second preset period of time (e.g., 20 minutes), the air conditioner 1000 may switch from the windless mode to the soft-off mode to save energy. When switching to the soft-off mode, the air conditioner 1000 may stop the operation of the blower 1003.

In addition, according to an embodiment of the disclosure, when the windless mode is switched to the soft-off mode, the air conditioner 1000 may control the blower 1003 to briefly perform a drying operation for the heat exchanger 1002 before stopping the operation of the blower 1003. For example, the air conditioner 1000 may briefly perform an operation of drying moisture formed in the heat exchanger 1002 in a blowing mode to prevent mold growth, and then completely stop the blowing operation. In this case, the air conditioner 1000 may adjust an RPM (or power consumption) of the blower 1003 to a preset RPM (or power consumption) in response to the drying operation.

According to an embodiment of the disclosure, the air conditioner 1000 may perform the drying operation for the heat exchanger 1002 for a preset period of time (e.g., 10 minutes). Also, according to an embodiment of the disclosure, the air conditioner 1000 may perform the drying operation for the heat exchanger 1002 until a humidity measured via the humidity sensor reaches a threshold humidity or less. When the drying operation for the heat exchanger 1002 is completed, the air conditioner 1000 may stop the operation of the blower 1003 and remain in a standby state.

In operation S1670, according to an embodiment of the disclosure, the air conditioner 1000 may continue to determine whether the person is absent for a third preset period of time after switching to the soft-off mode. For example, the air conditioner 1000 may continue to determine, via the radar sensor 1001, whether the person is absent for 20 minutes after switching to the soft-off mode.

When the person is detected again via the radar sensor 1001 within the third preset period of time (e.g., 20 minutes) after switching to the soft-off mode (NO in S1670), the air conditioner 1000 may switch the soft-off mode to the normal mode with a specific wind volume. For example, when the user sets the air conditioner 1000 to the strong wind mode, goes out, and then returns home after 10 minutes have elapsed since the operation mode of the air conditioner 1000 switched to the soft-off mode, the air conditioner 1000 may deactivate the soft-off mode and operate in the strong wind mode again.

In operation S1680, according to an embodiment of the disclosure, when the air conditioner 1000 continues to detect the absence of the person via the radar sensor 1001 for the third preset period of time after switching to the soft-off mode, the power of the air conditioner 1000 may be turned off.

When the power of the air conditioner 1000 is turned off, the radar sensor 1001 and the processor 1021 may also be deactivated. Accordingly, even when the person returns home after the power of the air conditioner 1000 is turned off, the air conditioner 1000 is unable to detect the person via the radar sensor 1001, and thus, the person needs to turn the power of the air conditioner 1000 back on when cooling is needed.

That is, according to an embodiment of the disclosure, when the user goes out for a long time with the air conditioner 1000 turned on, the operation of the air conditioner 1000 may be stopped after a preset period of time has elapsed, thereby saving energy. Moreover, because the user may go out and return home soon, even when the absence of the person is detected, the power of the air conditioner 1000 may not be immediately turned off, but the air conditioner 1000 may sequentially switch between the operation modes in the order of the normal mode, the windless mode, and the soft-off mode. Accordingly, when the person is detected again via the radar sensor 1001, the air conditioner 1000 may quickly return to the normal mode.

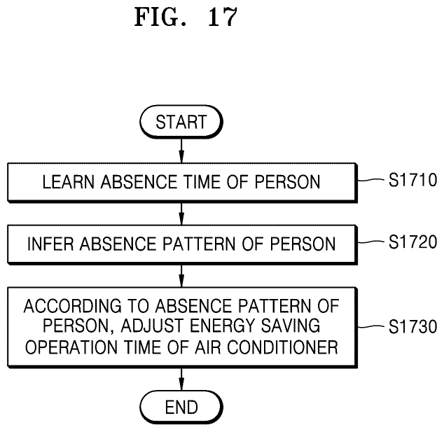

FIG. 17 is a flowchart to describe a method for the air conditioner 1000 to adjust an energy saving operation time according to an absence pattern of a person, according to an embodiment of the disclosure.

Referring to FIG. 17, a method for the air conditioner 1000 to adjust an operation time according to an absence pattern of a person may include operations S1710 to S1730. According to an embodiment of the disclosure, operations S1710 to S1730 may be executed by at least one processor included in the air conditioner 1000. The method for the air conditioner 1000 to adjust an operation time according to an absence pattern of a person is not limited to that shown in FIG. 17, and in one or more embodiments, operations not shown in FIG. 17 may be further included or some operations may be omitted.

In operation S1710, according to an embodiment of the disclosure, the air conditioner 1000 may learn an absence time of a person.

According to an embodiment of the disclosure, the air conditioner 1000 may collect data regarding the absence of the person via the radar sensor 1001. For example, when the person goes out with the air conditioner 1000 turned on, the air conditioner 1000 may identify, via the radar sensor 1001, that the person is absent and has left a detection area. The air conditioner 1000 may collect data regarding a time when the person is absent, data regarding a time when the person goes out and returns home, data regarding the total time for which the person is absent, data regarding a time period in which the person is absent, etc.

According to an embodiment of the disclosure, the air conditioner 1000 may learn the absence time of the person based on the data regarding the absence of the person, which is obtained via the radar sensor 1001. For example, the air conditioner 1000 may input the data regarding the absence of the person into an AI model and train the AI model with the absence time of the person.

In operation S1720, according to an embodiment of the disclosure, the air conditioner 1000 may infer an absence pattern of the person.

According to an embodiment of the disclosure, the air conditioner 1000 may infer the absence pattern of the person by using the AI model. For example, when the air conditioner 1000 inputs, into the AI model, the data regarding the absence of the person obtained via the radar sensor 1001, the AI model may learn the data regarding the absence of the person and infer the absence pattern of the person.

According to an embodiment of the disclosure, the air conditioner 1000 may infer whether an occupancy time of the person is short or whether the occupancy time is long. Also, the air conditioner 1000 may also infer whether the person goes out for a short time, which is within 20 minutes, and then returns home, or goes out for a long time, which is 2 hours or more, and then returns home. The air conditioner 1000 may also infer that the person takes a long occupancy time at night and a short occupancy time during the day, or vice versa.

In operation S1730, according to an embodiment of the disclosure, the air conditioner 1000 may adjust an energy saving operation time of the air conditioner 1000 according to the absence pattern of the person. That is, the air conditioner 1000 may adjust a time from a time point when the absence of the person is detected via the radar sensor 1001 until the power of the air conditioner 1000 is turned off.

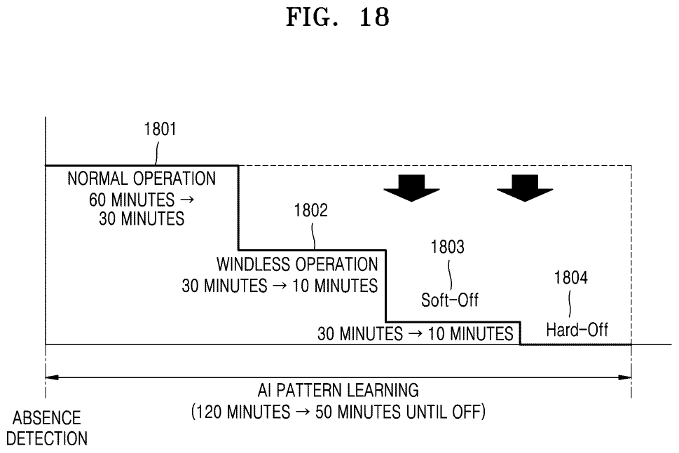

According to an embodiment of the disclosure, the air conditioner 1000 may control, according to the absence pattern of the person, at least one of a first preset period of time for switching the normal mode to the windless mode, a second preset period of time for switching the windless mode to the soft-off mode, or a third preset period of time for switching the soft-off mode to a hard-off mode (power off). For example, as a result of analyzing the absence pattern of the person, when the occupancy time is short and the person frequently goes out (e.g., leaves the detection area) for a long time, the air conditioner 1000 may shorten the first preset period of time, the second preset period of time, and the third preset period of time. That is, when the user goes out for a long time shortly after turning on the air conditioner 1000, the air conditioner 1000 may switch between operation modes at short time intervals in the order of the normal mode, the windless mode, the soft-off mode, and the hard-off mode. In this case, the total operation time may be reduced, thereby further saving energy. An operation of the air conditioner 1000 to adjust the energy saving operation time is described in more detail with reference to FIG. 18.

FIG. 18 is a diagram to describe an operation of the air conditioner 1000 to adjust an energy saving operation time according to an absence pattern of a person, according to an embodiment of the disclosure.

Referring to FIG. 18, according to an embodiment of the disclosure, when the absence of the person is detected, the air conditioner 1000 may maintain the normal mode with a specific wind volume for 60 minutes, and then, after 60 minutes have elapsed, switch the normal mode to the windless mode. When the air conditioner 1000 switches to the windless mode and the absence of the person maintains for 30 more minutes, the air conditioner 1000 may switch from the windless mode to the soft-off mode that terminates a cooling function. When the absence of the person maintains for 30 more minutes even after switching to the soft-off mode, the power of the air conditioner 1000 may be completely turned off. Therefore, according to an embodiment of the disclosure, when the person is absent for 120 minutes, in order to save energy, the air conditioner 1000 may sequentially switch from the normal mode to the windless mode and the soft-off mode and then be turned off.

In addition, according to an embodiment of the disclosure, the air conditioner 1000 may learn an absence time of the person, and when the occupancy time of the person is short, may shorten the energy saving operation time. For example, the air conditioner 1000 may shorten a first preset period of time (1801) for switching from the normal mode to the windless mode from 60 minutes to 30 minutes, shorten a second preset period of time (1802) for switching from the windless mode to the soft-off mode from 30 minutes to 10 minutes, and shorten a third preset period of time (1803) for switching from the soft-off mode to the hard-off mode from 30 minutes to 10 minutes. That is, when the occupancy time of the person is short, the air conditioner 1000 may maintain the normal mode for only 30 minutes after the absence of the person is detected, and then switch to the windless mode. When the air conditioner 1000 switches to the windless mode and the absence of the person maintains for a fourth preset period of time (1804) (e.g., 10 minutes), the air conditioner 1000 may switch from the windless mode to the soft-off mode. When the absence of the person maintains for 10 more minutes even after switching to the soft-off mode, the power of the air conditioner 1000 may be completely turned off.

Therefore, according to an embodiment of the disclosure, when the occupancy time of the person is short, the air conditioner 1000 may shorten a time (energy saving operation time) from a time point when the absence is detected until the power is turned off from 120 minutes to 50 minutes. That is, according to an embodiment of the disclosure, inefficient driving (of the air conditioner 1000) in the absence of the person may be eliminated, thereby reducing energy costs and reducing the maintenance of the air conditioner 1000.

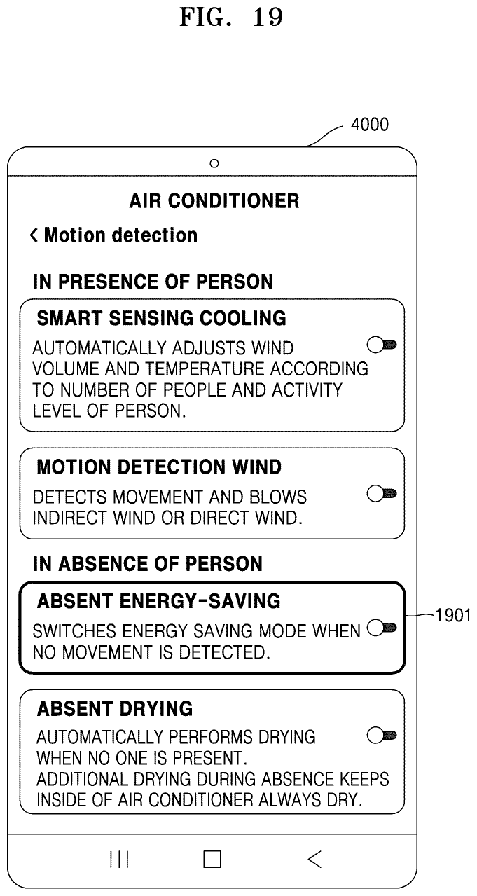

FIG. 19 is a diagram of a GUI for setting an energy saving mode, according to an embodiment of the disclosure.

A user may execute a specific application (e.g., a home appliance management application) on the user terminal 4000. In this case, the user terminal 4000 may display an execution window of the specific application. The execution window of the specific application may display a list of home appliances of a user, which are registered to the server 2000. The user may enter a settings screen for the air conditioner 1000 by selecting an air conditioner icon in the execution window of the specific application. The user may select an absence energy-saving item 1901 in the settings screen for the air conditioner 1000.

When the user selects the absence energy-saving item 1901, the user terminal 4000 may transmit, to the server 2000, information that the absence energy-saving item 1901 has been selected. When the information that the absence energy-saving item 1901 has been selected is received from the user terminal 4000, the server 2000 may transmit, to the air conditioner 1000, a command to set an absence energy-saving mode.

The air conditioner 1000 may set the absence energy-saving mode in response to the command from the server 2000. For example, when movement of a person is not detected via the radar sensor 1001, the air conditioner 1000 may perform an energy saving operation by sequentially switching the normal mode to the windless mode, the soft-off mode, and the hard-off mode (power off).

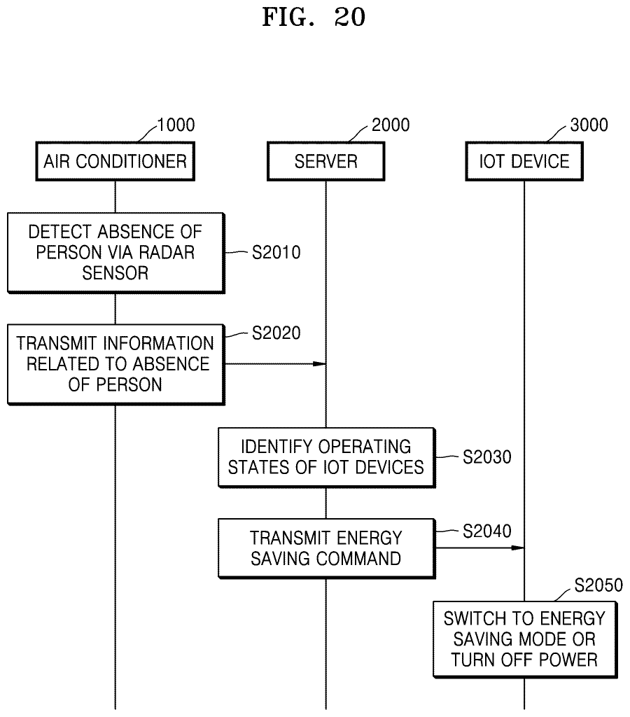

FIG. 20 is a flowchart to describe a method for IoT devices connected to the air conditioner 1000 to switch to an energy saving mode, according to an embodiment of the disclosure.

In operation S2010, according to an embodiment of the disclosure, the air conditioner 1000 may detect the absence of a person via the radar sensor 1001.

According to an embodiment of the disclosure, when the person goes out with the power of the air conditioner 1000 turned on, the person may leave a detection area of the radar sensor 1001. When the person leaves the detection area, the radar sensor 1001 may no longer detect a location (movement) of the person. Accordingly, when location information (movement information) about the person is no longer received from the radar sensor 1001, the processor 1021 of the air conditioner 1000 may detect the absence of the person.

In operation S2020, according to an embodiment of the disclosure, when the absence of the person is detected, the air conditioner 1000 may transmit, to the server 2000, information related to the absence of the person.

According to an embodiment of the disclosure, the air conditioner 1000 may transmit the information related to the absence of the person to the server 2000 via the communication interface 1030 (see FIG. 8). For example, the air conditioner 1000 may transmit, to the server 2000, information that the person is currently absent, information about a time point when the absence of the person is detected, information about an absence time, etc.

In operation S2030, according to an embodiment of the disclosure, when the information related to the absence of the person is received from the air conditioner 1000, the server 2000 may identify operating states of IoT devices. For example, the server 2000 may identify at least one IoT device 3000 currently in operation from among IoT devices registered to the server 2000 with the same account as the air conditioner 1000.

In operation S2040, according to an embodiment of the disclosure, the server 2000 may transmit an energy saving command to the at least one IoT device 3000 currently in operation. For example, because the person is absent, in order to save energy, the server 2000 may transmit, to the at least one IoT device 3000 currently in operation, a command to operate in an energy saving mode or a command to turn off the power.

In operation S2050, according to an embodiment of the disclosure, when the energy saving command is received from the server 2000, the IoT device 3000 may switch to the energy saving mode or be turned off.

According to an embodiment of the disclosure, when a separate energy saving mode is present in the IoT device 3000, the IoT device 3000 may save energy costs by switching the normal mode to the energy saving mode. In contrast, when no separate energy saving mode is present in the IoT device 3000, the IoT device 3000 may also be turned off to save energy costs.

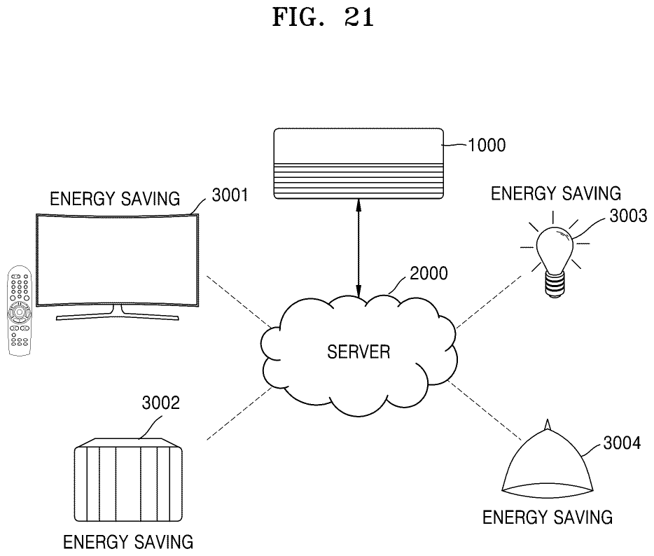

Therefore, according to an embodiment of the disclosure, when the absence of the person is detected via the radar sensor 1001, the air conditioner 1000 may switch operation modes of various IoT devices to the energy saving mode, thereby saving energy, the various IoT devices being located within a space where the air conditioner 1000 is installed. An operation of various IoT devices to switch to the energy saving mode is described in further detail with reference to FIG. 21.

FIG. 21 is a diagram to describe an operation of IoT devices connected to the air conditioner 1000 to switch to an energy saving mode, according to an embodiment of the disclosure.

Referring to FIG. 21, when a user goes out with the air conditioner 1000 turned on, the air conditioner 1000 may detect the absence of a person via the radar sensor 1001 and operate in the energy saving mode after a preset period of time.

In addition, when the absence of the person is detected, the air conditioner 1000 may transmit, to the server 2000, information about the absence of the person. In this case, when the person did not return home even after a preset period of time (e.g., 1 hour) has elapsed, the server 2000 may transmit an energy saving command to IoT devices currently in operation. For example, when a TV 3001, an air purifier 3002, a first lighting apparatus 3003, and a second lighting apparatus 3004, which are installed in the same space as the air conditioner 1000, are currently operating, the server 2000 may transmit the energy saving command to each of the TV 3001, the air purifier 3002, the first lighting apparatus 3003, and the second lighting apparatus 3004. In this case, the TV 3001, the air purifier 3002, the first lighting apparatus 3003, and the second lighting apparatus 3004 may switch to the energy saving mode or be turned off.

Therefore, according to an embodiment of the disclosure, when the person is absent, the air conditioner 1000 may save energy costs by switching other home appliances connected via the server 2000 to the energy saving mode or turning off the power of the other home appliances.

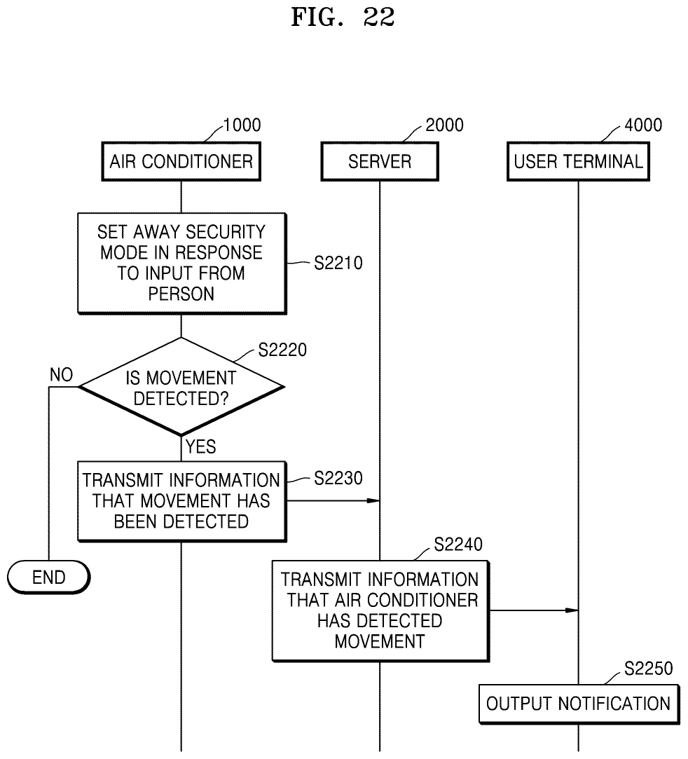

FIG. 22 is a flowchart to describe a method for the air conditioner 1000 to output a security detection notification, according to an embodiment of the disclosure.

In operation S2210, according to an embodiment of the disclosure, the air conditioner 1000 may set an away security mode in response to an input from a person.

The away security mode may be a mode that provides a notification to a user when unintended movement is detected at home while the user is out. When the air conditioner 1000 operates in the away security mode, a cooling (or heating) function may be deactivated, and the radar sensor 1001, the processor 1021, and the communication interface 1030 may be activated to detect unintended movement at home.

In operation S2220, according to an embodiment of the disclosure, the air conditioner 1000 may determine whether movement is detected via the radar sensor 1001 while operating in the away security mode. For example, when an outsider enters a detection area of the radar sensor 1001, the air conditioner 1000 may detect movement of the outsider via the radar sensor 1001. The outsider may be, but is not limited to, a person other than the user, such as an intruder, a family member, or a babysitter.

In operation S2230, according to an embodiment of the disclosure, when movement is detected while operating in the away security mode, the air conditioner 1000 may transmit, to the server 2000, information that the movement has been detected. For example, the processor 1021 of the air conditioner 1000 may transmit, to the server 2000 via the communication interface 1030, the information that the movement has been detected.

In operation S2240, according to an embodiment of the disclosure, when the information that the movement has been detected is received from the air conditioner 1000, the server 2000 may transmit, to the user terminal 4000, information that the air conditioner 1000 has detected movement.

For example, the server 2000 may identify the user terminal 4000 (e.g., a smartphone) registered with the same account as the air conditioner 1000 and transmit, to the user terminal 4000, information that the air conditioner 1000 has detected movement at home.

In operation S2250, according to an embodiment of the disclosure, when the information that the air conditioner 1000 has detected movement is received, the user terminal 4000 may output a notification. For example, the user terminal 4000 may output, via a specific application (e.g., a home appliance management application), a security detection notification indicating that movement is detected at home while the away security mode is in operation.

In this case, through notifications output on the user terminal 4000, the user may identify that another family member has returned home while the user is out or may identify that an outsider has intruded without permission.

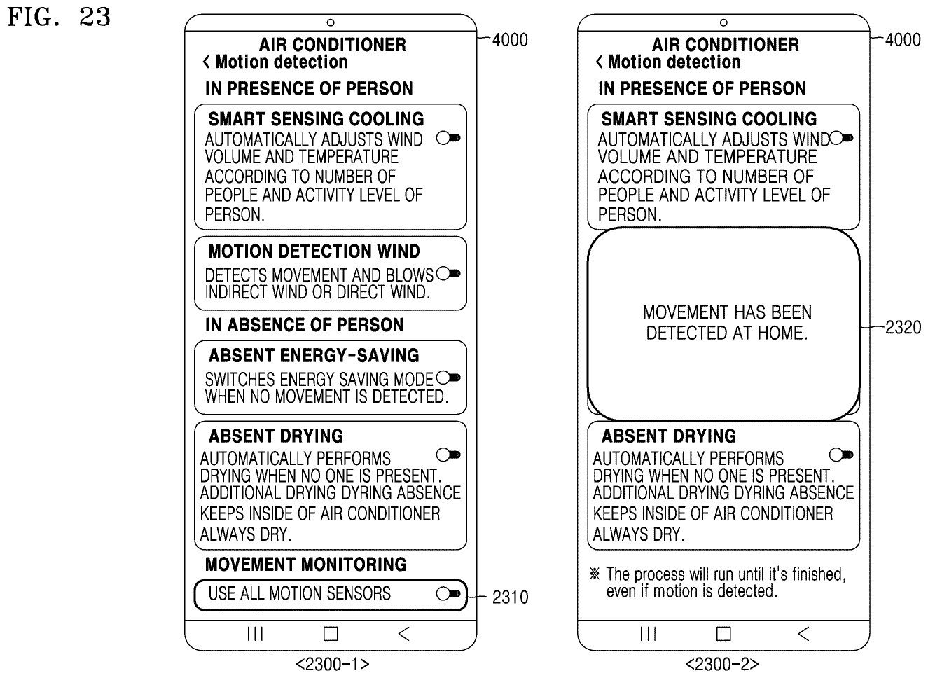

Therefore, according to an embodiment of the disclosure, the air conditioner 1000 may detect unintended movement at home by using the radar sensor 1001 and provide a security detection notification to the user, thereby enhancing the security of the home. An operation of the user terminal 4000 to output the security detection notification is described in a little more detail with reference to FIG. 23.

FIG. 23 is a diagram to describe an operation of the user terminal 4000 to output a security detection notification, according to an embodiment of the disclosure.

Referring to view 2300-1 of FIG. 23, a user may execute a specific application (e.g., a home appliance management application) on the user terminal 4000. In addition, the user may select an item 2310 for activating the away security mode on an execution window of the specific application. In this case, the user terminal 4000 may transmit, to the server 2000, information that a user input for activating the away security mode has been received. Based on the user input for activating the away security mode, the server 2000 may transmit, to the air conditioner 1000, a command to set the away security mode.

The air conditioner 1000 may set the away security mode in response to the command from the server 2000 and monitor whether unintended movement is detected by using the radar sensor 1001.

Referring to view 2300-2 of FIG. 23, when an outsider enters the home without permission, the air conditioner 1000 may detect movement of the outsider by using the radar sensor 1001. In addition, the air conditioner 1000 may transmit, to the server 2000, information that movement of the outsider has been detected, and the server 2000 may transmit, to the user terminal 4000, information that the air conditioner 1000 has detected movement of the outsider. In this case, the user terminal 4000 may output, on a screen, a security detection notification 2320 indicating that unintended movement has been detected at home. In FIG. 23, a case where the security detection notification 2320 is visually displayed is shown as an example, but the disclosure is not limited thereto. The user terminal 4000 may output, via a speaker, a warning sound or a speech message indicating that movement has been detected at home. The user may check the security detection notification 2320 and quickly take appropriate measures for security.

In addition, according to an embodiment of the disclosure, the user may deactivate the away security mode before returning home. For example, the user may perform an input for deactivating the away security mode on the user terminal 4000. In this case, the user terminal 4000 may transmit, to the server 2000, information that a user input for deactivating the away security mode has been received. Based on the user input for deactivating the away security mode, the server 2000 may transmit, to the air conditioner 1000, a command to deactivate the away security mode.

According to an embodiment of the disclosure, even if the user does not deactivate the away security mode before returning home, when information that the user terminal 4000 is located at home is obtained via an application installed on the user terminal 4000, the server 2000 may transmit, to the air conditioner 1000, a command to deactivate the away security mode. For example, the user terminal 4000 may periodically transmit information about a current location to the server 2000 via an application associated with the server 2000. When the user returns home with the user terminal 4000, the user terminal 4000 may identify that the user terminal 4000 is currently located at home, based on location information obtained via GPS or connection state information with a router, and transmit, to the server 2000, information that the user terminal 4000 is located at home. When the user terminal 4000 is located at home, the user may be considered to have returned home, and thus, the server 2000 may transmit, to the air conditioner 1000, a command to deactivate the away security mode.

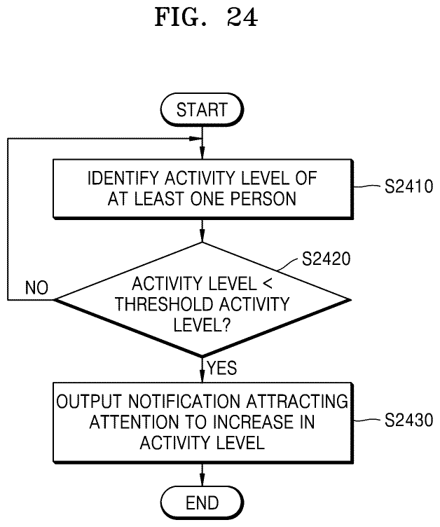

FIG. 24 is a flowchart to describe a method for the air conditioner 1000 to output a notification attracting a person's attention to an increase in the activity level, according to an embodiment of the disclosure.

Referring to FIG. 24, the method for the air conditioner 1000 to output a notification attracting a person's attention to an increase in the activity level may include operations S2410 to S2430. According to an embodiment of the disclosure, operations S2410 to S2430 may be executed by at least one processor included in the air conditioner 1000. The method for the air conditioner 1000 to output a notification attracting a person's attention to an increase in the activity level is not limited to that shown in FIG. 24, and in one or more embodiments, operations not shown in FIG. 24 may be further included or some operations may be omitted.

In operation S2410, according to an embodiment of the disclosure, the air conditioner 1000 may identify an activity level of at least one person.

According to an embodiment of the disclosure, the air conditioner 1000 may detect movement of the person based on a change in coordinates measured by the radar sensor 1001. For example, the air conditioner 1000 may identify the activity level of the person by calculating a distance by which the person moves per second based on the change in coordinates of the person measured by the radar sensor 1001. The air conditioner 1000 may identify that the greater the distance by which the person moves per second, the greater the activity level of the person, and may identify that the smaller the distance by which the person moves per second, the activity level of the person.

In operation S2420, according to an embodiment of the disclosure, the air conditioner 1000 may determine whether the activity level of the at least one person is less than a threshold activity level.

According to an embodiment of the disclosure, the air conditioner 1000 may determine whether the activity level of the person is less than the threshold activity level for a preset period of time. The threshold activity level for the preset period of time can be predefined in advance. For example, the air conditioner 1000 may determine whether the activity level of the person is less than the threshold activity level (e.g., 10%) for 30 minutes. The preset period of time is not limited to 30 minutes and may be arbitrarily selected or changed by a user.

According to an embodiment of the disclosure, when the activity level of the person is more than or equal to the threshold activity level for the preset period of time (NO in S2420), the air conditioner 1000 may continue to monitor the activity level of the person.

In operation S2430, according to an embodiment of the disclosure, when the activity level of the person is less than the threshold activity level for the preset period of time (YES in S2420), the air conditioner 1000 may output a notification attracting the person's attention to an increase in the activity level.

According to an embodiment of the disclosure, when the activity level of the at least one person is less than the threshold activity level for the preset period of time, the air conditioner 1000 may output a notification attracting attention to an increase in the activity level, through the speaker of the air conditioner 1000, the display of the air conditioner 1000, and/or the user terminal 4000 connected via the server 2000. For example, as a result of monitoring the activity level of the person by using the radar sensor 1001, when the person is hardly moving for a long period of time, the air conditioner 1000 may visually and/or audibly output a notification message to induce movement of the person for the sake of the health of the person.

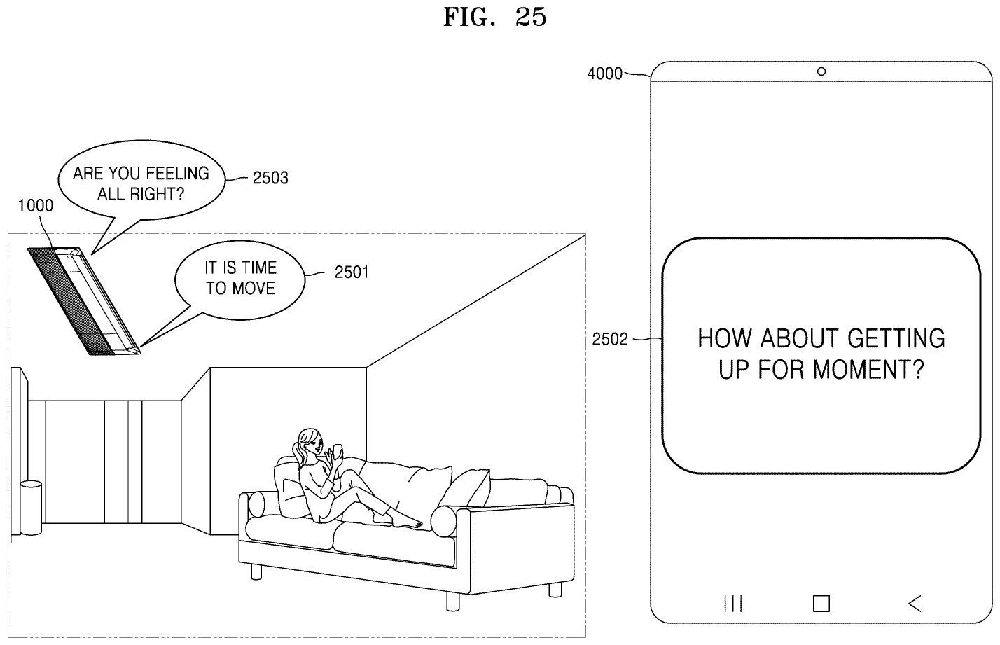

The user may check the notification attracting attention to an increase in the activity level and may increase the activity level for his or her health. An operation of the air conditioner 1000 to output a notification attracting attention to an increase in the activity level is described in more detail with reference to FIG. 25.

FIG. 25 is a diagram to describe an operation of the air conditioner 1000 or the user terminal 4000 to output a notification attracting a person's attention to an increase in the activity level, according to an embodiment of the disclosure.

Referring to FIG. 25, a user may sit on a sofa and watch a movie on a smartphone for a long period of time. In this case, the air conditioner 1000 may monitor the activity level of the person by using the radar sensor 1001. Because the user is sitting on the sofa, the activity level of the person calculated by the air conditioner 1000 may be close to 0. As a result of monitoring the activity level of the person, in which the activity level of the person is less than the threshold activity level for a preset period of time (e.g., 1 hour), the air conditioner 1000 may output a notification attracting attention to an increase in the activity level. For example, the air conditioner 1000 may output, through the speaker, a speech notification 2501 saying “It is time to move”.

According to an embodiment of the disclosure, when the activity level of the person is less than the threshold activity level for the preset period of time (e.g., 1 hour), the air conditioner 1000 may transmit, to the server 2000, information that the activity level of the person is less than the threshold activity level. In this case, the server 2000 may transmit, to the user terminal 4000, a command to output a notification attracting attention to an increase in the activity level. In response to the command from the server 2000, the user terminal 4000 may output, in the execution window of the application, a notification message 2502 saying “How about getting up for a moment?”.

According to an embodiment of the disclosure, the air conditioner 1000 may also periodically transmit, to the server 2000, information about the activity level of the person. In this case, when the activity level of the person is less than the threshold activity level for a preset period of time, the server 2000 may also transmit, to the user terminal 4000, a command to output a notification attracting attention to an increase in the activity level.

According to an embodiment of the disclosure, the user may check the notification output from the air conditioner 1000 or the user terminal 4000 and increase the activity level for his or her health.

According to an embodiment of the disclosure, the air conditioner 1000 may measure heart rate or respiration rate of the person by using the radar sensor 1001. When the heart rate or respiration rate of the person is outside a reference range, the air conditioner 1000 may also output a notification related to the health state. For example, the air conditioner 1000 may output, through the speaker, a speech notification 2503 asking “Are you feeling all right?”. Also, when the heart rate or respiration rate of the person is outside the reference range, the air conditioner 1000 may transmit, to the server 2000, information that the heart rate or respiration rate of the person is unstable. In this case, the server 2000 may transmit, to a pre-designated terminal (e.g., the user terminal 4000, a family member terminal, a medical institution terminal, etc.), information that the heart rate or respiration rate of the person is unstable.

According to an embodiment of the disclosure, an air conditioner may be provided, which detects a location of a person by using a radar sensor and provides various convenient services to the person based on the location of the person.

According to an embodiment of the disclosure, an air conditioner 1000 may include an indoor unit main body 1010 including a heat exchanger 1002, a blower 1003, and a blade 1004, a radar sensor 1001 provided inside the indoor unit main body 1010 and directed toward a floor surface, a memory 1022 storing one or more instructions, and at least one processor 1021. The at least one processor 1021 may be configured to execute the one or more instructions to obtain, by using the radar sensor 1001, information about a location of at least one person detected within a certain range from the air conditioner 1000. The at least one processor 1021 may identify, by using the information about the location of the at least one person, an activity level of the at least one person. The at least one processor 1021 may determine, based on the activity level of the at least one person, a wind volume of the air conditioner 1000. The at least one processor 1021 may control the blower 1003 to discharge wind with the determined wind volume. Therefore, according to an embodiment of the disclosure, the air conditioner 1000 may adaptively adjust a wind volume according to the activity level of the person by using the radar sensor 1001, thereby providing pleasantness to the person. For example, when the activity level of the person is high, the air conditioner 1000 may adjust the wind volume to be high, thereby allowing an indoor temperature to quickly reach a set temperature.

According to an embodiment of the disclosure, the indoor unit main body 1010 may include a sensor mounting portion 1011 on which the radar sensor 1001 is mounted to be tilted at a preset angle and directed toward the floor surface. When the indoor unit main body 1010 is located on one side of a ceiling, the preset angle may be an angle between 50° and 70°. The preset angle may be an angle between 60° and 65°. For example, the preset angle may be 63°. According to an embodiment of the disclosure, because the radar sensor 1001 is tilted at a preset angle and directed toward the floor surface such that a detection range of the radar sensor 1001 may be expanded.

According to an embodiment of the disclosure, the at least one processor 1021 may determine, based on a number of the at least one person detected within the certain range from the air conditioner 1000, the wind volume of the air conditioner 1000. According to an embodiment of the disclosure, the air conditioner 1000 may adjust the wind volume based on the number of people, thereby allowing the indoor temperature to quickly reach a set temperature when there are many people.

According to an embodiment of the disclosure, when an absence of the person is detected via the radar sensor 1001 for a first preset period of time, the at least one processor 1021 may switch an operation mode of the air conditioner 1000 from a normal mode to a windless mode, wherein the normal mode operates with a specific wind volume, and the windless mode closes the blade 1004. When the absence of the person is continuously detected via the radar sensor 1001 for a second preset period of time after switching to the windless mode, the at least one processor 1021 may switch the windless mode to a soft-off mode, wherein the soft-off mode stops a cooling operation. When the absence of the person is continuously detected via the radar sensor 1001 for a third preset period of time after switching to the soft-off mode, the at least one processor 1021 may turn off power of the air conditioner 1000. Therefore, according to an embodiment of the disclosure, the air conditioner 1000 may gradually switch to an energy saving mode when the person is absent, thereby saving energy costs.

According to an embodiment of the disclosure, the at least one processor 1021 may infer an absence pattern of the person by using an artificial intelligence (AI) model. The at least one processor 1021 may adjust the first preset period of time, the second preset period of time, or the third preset period of time according to the absence pattern of the person. According to an embodiment of the disclosure, the air conditioner 1000 may shorten an energy saving operation time according to the absence pattern of the person, thereby reducing energy costs.

According to an embodiment of the disclosure, in the soft-off mode, the radar sensor 1001 and the at least one processor 1021 may be activated, and the heat exchanger 1002, the blower 1003, and the blade 1004 may be deactivated.

According to an embodiment of the disclosure, when the at least one person is detected via the radar sensor 1001 within the second preset period of time after switching to the windless mode, the at least one processor 1021 may switch the windless mode to the normal mode operating with the specific wind volume. When the at least one person is detected via the radar sensor 1001 within the third preset period of time after switching to the soft-off mode, the at least one processor 1021 may switch the soft-off mode to the normal mode operating with the specific wind volume. According to an embodiment of the disclosure, when the person who has left home is detected again by using the radar sensor 1001, the air conditioner 1000 may quickly return to the normal mode.

According to an embodiment of the disclosure, when the windless mode is switched to the soft-off mode, the at least one processor 1021 may control the blower 1003 to perform a drying operation for the heat exchanger 1002. According to an embodiment of the disclosure, the air conditioner 1000 may prevent mold growth by performing a drying operation for the heat exchanger 1002 when the person is absent.

According to an embodiment of the disclosure, when an absence of the person is detected via the radar sensor 1001, the at least one processor 1021 may transmit, to a server 2000, information related to the absence of the person. Therefore, according to an embodiment of the disclosure, when the air conditioner 1000 detects the absence of the person, the server 2000 may switch operation modes of other IoT devices to the energy saving mode, thereby saving energy costs, the other IoT devices being installed in the same space as the air conditioner 1000.

According to an embodiment of the disclosure, the at least one processor 1021 may set an away security mode in response to an input from the person. When a movement is detected via the radar sensor 1001 while operating in the away security mode, the at least one processor 1021 may output, through a user terminal 4000 connected to the server 2000, a notification indicating that the movement has been detected. Therefore, according to an embodiment of the disclosure, the air conditioner 1000 may enhance the security of the home by using the radar sensor 1001.

According to an embodiment of the disclosure, when an input for setting a direct wind mode is received, the at least one processor 1021 may adjust, based on the location of the at least one person detected via the radar sensor 1001, an angle of the blade 1004 such that wind is directly blown toward the at least one person. According to an embodiment of the disclosure, the air conditioner 1000 may accurately detect the location of the person by using the radar sensor 1001, thereby finely adjusting the angle of the blade 1004.

According to an embodiment of the disclosure, when a plurality of people are detected via the radar sensor 1001, the at least one processor 1021 may adjust the angle of the blade 1004 such that wind is alternately directed toward the plurality of people.

According to an embodiment of the disclosure, when an input for setting an indirect wind mode is received, the at least one processor 1021 may adjust, based on the location of the at least one person detected via the radar sensor 1001, an angle of the blade 1004 such that wind is directed outward by a certain radius from the at least one person.

According to an embodiment of the disclosure, when the activity level of the at least one person is less than a threshold activity level for a certain period of time, the at least one processor 1021 may output, through a speaker of the air conditioner 1000, a display of the air conditioner 1000, or the user terminal 4000 connected via the server 2000, a notification attracting attention to an increase in the activity level. Therefore, according to an embodiment of the disclosure, the air conditioner 1000 may also manage the health of the person by using the radar sensor 1001.

According to an embodiment of the disclosure, a method of controlling an operation of an air conditioner 1000 may include, by using a radar sensor 1001 provided inside an indoor unit main body 1010 and directed toward a floor surface, obtaining information about a location of at least one person detected within a certain range from the air conditioner 1000 (S910), by using the information about the location of the at least one person, identifying an activity level of the at least one person (S920), based on the activity level of the at least one person, determining a wind volume of the air conditioner 1000 (S930), and controlling a blower 1003 of the air conditioner 1000 to discharge wind with the determined wind volume (S940).

According to an embodiment of the disclosure, the indoor unit main body 1010 may include a sensor mounting portion 1011 on which the radar sensor 1001 is mounted to be tilted at a preset angle and directed toward the floor surface.

According to an embodiment of the disclosure, the determining of the wind volume of the air conditioner 1000 may include, based on a number of the at least one person detected within the certain range from the air conditioner 1000, determining the wind volume of the air conditioner 1000 (S1120).

According to an embodiment of the disclosure, the method of controlling the operation of the air conditioner 1000 may include, when an absence of the person is detected via the radar sensor 1001 for a first preset period of time, switching an operation mode of the air conditioner 1000 from a normal mode to a windless mode, wherein the normal mode operates with a specific wind volume, and the windless mode closes the blade 1004, when the absence of the person is continuously detected via the radar sensor 1001 for a second preset period of time after switching to the windless mode, switching the windless mode to a soft-off mode, wherein the soft-off mode stops a cooling operation, and when the absence of the person is continuously detected via the radar sensor 1001 for a third preset period of time after switching to the soft-off mode, turning off power of the air conditioner 1000.

According to an embodiment of the disclosure, the method of controlling the operation of the air conditioner 1000 may include, by using an artificial intelligence (AI) model, inferring an absence pattern of the person (S1720), and according to the absence pattern of the person, adjusting the first preset period of time, the second preset period of time, or the third preset period of time.

A machine-readable storage medium may be provided in the form of a non-transitory storage medium. In this regard, the “non-transitory storage medium” simply means that the storage medium is a tangible apparatus and does not include a signal (e.g., an electromagnetic wave), but this term does not differentiate between where data is semi-permanently stored in the storage medium and where the data is temporarily stored in the storage medium. For example, the “non-transitory storage medium” may include a buffer in which data is temporarily stored.

According to an embodiment of the disclosure, the method according to various embodiments provided in the present document may be provided by being included in a computer program product. The computer program product may be traded as a product between a seller and a buyer. The computer program product may be distributed in the form of a machine-readable storage medium (e.g., compact disc-ROM (CD-ROM) or universal serial bus (USB) flash drive), or distributed (e.g., downloaded or uploaded) through an application store, or directly or online between two user apparatuses (e.g., smartphones). In the case of online distribution, at least a portion of a computer program product (e.g., a downloadable application) may be temporarily stored in a machine-readable storage medium, such as memory of a manufacturer's server, an application store's server, or a relay server, or may be temporarily generated.

What is claimed is:

1. An air conditioner comprising an indoor unit main body including a heat exchanger, a blower, and a blade, the air conditioner comprising:
a radar sensor provided inside the indoor unit main body and configured to detect at least one person; and
a sensor mounting portion on which the radar sensor is mounted to be tilted at a preset angle and directed toward a floor surface,
wherein, when the indoor unit main body is located on one side of a ceiling, the preset angle is between 50° and 70°.

2. The air conditioner of claim 1, wherein the preset angle is between 60° and 65°.

3. The air conditioner of claim 1, further comprising:
memory storing one or more instructions; and
at least one processor configured to execute the one or more instructions to:
by using the radar sensor, obtain information about a location of the at least one person detected within a certain range from the air conditioner;
by using the information about the location of the at least one person, identify an activity level of the at least one person;
based on the activity level of the at least one person, determine a wind volume of the air conditioner; and
control the blower to discharge wind with the wind volume determined.

4. The air conditioner of claim 3, wherein the at least one processor is further configured to, based on a number of the at least one person detected within the certain range from the air conditioner, determine the wind volume of the air conditioner.

5. The air conditioner of claim 3, wherein the at least one processor is further configured to:
when an absence of the at least one person is detected via the radar sensor for a first preset period of time, switch an operation mode of the air conditioner from a normal mode to a windless mode, wherein the normal mode operates with a specific wind volume, and the windless mode closes the blade;
when the absence of the at least one person is continuously detected via the radar sensor for a second preset period of time after switching to the windless mode, switch the windless mode to a soft-off mode, wherein the soft-off mode stops a cooling operation; and
when the absence of the at least one person is continuously detected via the radar sensor for a third preset period of time after switching to the soft-off mode, turn off power of the air conditioner.

6. The air conditioner of claim 5, wherein the at least one processor is further configured to:
by using an artificial intelligence (AI) model, infer an absence pattern of the at least one person; and
according to the absence pattern of the at least one person, adjust the first preset period of time, the second preset period of time, or the third preset period of time.

7. The air conditioner of claim 5, wherein, in the soft-off mode, the radar sensor and the at least one processor are activated, and the heat exchanger, the blower, and the blade are deactivated.

8. The air conditioner of claim 5, wherein the at least one processor is further configured to:
when the at least one person is detected via the radar sensor within the second preset period of time after switching to the windless mode, switch the windless mode to the normal mode operating with the specific wind volume; and
when the at least one person is detected via the radar sensor within the third preset period of time after switching to the soft-off mode, switch the soft-off mode to the normal mode operating with the specific wind volume.

9. The air conditioner of claim 5, wherein the at least one processor is further configured to, when the windless mode is switched to the soft-off mode, control the blower to perform a drying operation for the heat exchanger.

10. The air conditioner of claim 3, wherein the at least one processor is further configured to, when an absence of the at least one person is detected via the radar sensor, transmit, to a server, another information related to the absence of the at least one person.

11. The air conditioner of claim 3, wherein the at least one processor is further configured to:
in response to an input from the at least one person, set an away security mode; and
when a movement is detected via the radar sensor while operating in the away security mode, output, through a user terminal, a notification indicating that the movement has been detected, the user terminal being connected to a server.

12. The air conditioner of claim 3, wherein the at least one processor is further configured to, when an input for setting a direct wind mode is received, based on the location of the at least one person detected via the radar sensor, adjust an angle of the blade such that the wind is directly blown toward the at least one person.

13. The air conditioner of claim 12, wherein the at least one processor is further configured to, when a plurality of people are detected via the radar sensor, adjust the angle of the blade such that the wind is alternately directed toward the plurality of people.

14. The air conditioner of claim 3, wherein the at least one processor is further configured to, when an input for setting an indirect wind mode is received, based on the location of the at least one person detected via the radar sensor, adjust an angle of the blade such that the wind is directed outward by a certain radius away from the at least one person.

15. The air conditioner of claim 3, wherein the at least one processor is further configured to, when the activity level of the at least one person is less than a threshold activity level for a certain period of time, output a notification to increase the activity level through a speaker of the air conditioner, a display of the air conditioner, or a user terminal connected via a server.

16. A method of controlling an operation of an air conditioner including an indoor unit main body, the method comprising:
by using a radar sensor provided inside the indoor unit main body and directed toward a floor surface, obtaining information about a location of at least one person detected within a certain range from the air conditioner;
by using the information about the location of the at least one person, identifying an activity level of the at least one person;
based on the activity level of the at least one person, determining a wind volume of the air conditioner; and
controlling a blower of the air conditioner to discharge wind with the wind volume determined.

17. The method of claim 16, wherein the indoor unit main body further comprises a sensor mounting portion on which the radar sensor is mounted to be tilted at a preset angle and directed toward the floor surface.

18. The method of claim 16, wherein the determining of the wind volume of the air conditioner comprises, based on a number of the at least one person detected within the certain range from the air conditioner, determining the wind volume of the air conditioner.

19. The method of claim 16, further comprising:
when an absence of the at least one person is detected via the radar sensor for a first preset period of time, switching an operation mode of the air conditioner from a normal mode to a windless mode, wherein the normal mode operates with a specific wind volume, and the windless mode closes a blade;
when the absence of the at least one person is continuously detected via the radar sensor for a second preset period of time after switching to the windless mode, switching the windless mode to a soft-off mode, wherein the soft-off mode stops a cooling operation; and
when the absence of the at least one person is continuously detected via the radar sensor for a third preset period of time after switching to the soft-off mode, turning off power of the air conditioner.

20. The method of claim 19, further comprising:
by using an artificial intelligence (AI) model, inferring an absence pattern of the at least one person; and
according to the absence pattern of the at least one person, adjusting the first preset period of time, the second preset period of time, or the third preset period of time.
